(19) United States
(12) Patent Application Publication
(10) Pub. No.: US 2008/0292194 A1
(43) Pub. Date: Nov. 27, 2008

(54) Method and System for Automatic Detection and Segmentation of Tumors and Associated Edema (Swelling) in Magnetic Resonance (Mri) Images

(76) Inventors: Mark Schmidt, Edmonton (CA); Russell Greiner, Edmonton (CA); Albert D. Murtha, Edmonton (CA)

Correspondence Address: VENABLE LLP, P.O. BOX 34385, WASHINGTON, DC, 20043-9998, US

(21) Appl. No.: 11/912,864

(22) PCT Filed: Apr. 27, 2006
(86) PCT No.: PCT/CA2006/000691

§ 371 Date: Apr. 30, 2008

Related U.S. Application Data
(60) Provisional application No. 60/675,085, filed on Apr. 27, 2005.
(60) Provisional application No. 60/730,008, filed on Oct. 26, 2005.

(51) Int. Cl. G06K 9/64; G06K 9/00

(52) U.S. Cl. 382/217; 382/131

(57) ABSTRACT

A method and system for segmenting an object represented in one or more input images, each of the one or more input images comprising a plurality of pixels. The method comprising: aligning the one or more input images with one or more corresponding template images each comprising a plurality of pixels; extracting features of each of the one or more input images and one or more template images; and classifying each pixel, or a group of pixels, in the one or more input images based on the measured features of the one or more input images and the one or more corresponding template images in accordance with a classification model mapping image properties or features to a respective class so as to segment the object represented in the one or more input images according to the classification of each pixel or group of pixels.

### FIELD OF THE APPLICATION

The application relates to the field of computer vision, machine learning, and pattern recognition, and particularly to a method and system for segmenting an object represented in one or more images, and more particularly to automatic detection and segmentation of tumors and associated edema (swelling) in magnetic resonance imaging (MRI) images.

### BACKGROUND

Magnetic Resonance Imaging (MRI) images may be used in the detection of tumors (e.g., brain tumors) or associated edema. This is typically done by a healthcare professional. It would be desirable to automatically detect and segment tumors or associated edema. Traditional methods are not suitable for analyzing MRI images in this manner due to the properties of MRI images which make the image intensities unsuitable for direct use in segmentation, and due to the visual properties of tumors in standard MRI images.

Using traditional methods, MRI image intensities cannot be used directly in segmentation due to the following factors:
1. Local Noise: The measurement made at each pixel is corrupted by noise, and thus the intensities do not correspond exactly to the true measured signal.
2. Partial Volume Effects: Since structural elements of human anatomy can be smaller than the size of the recorded regions, some pixels represent multiple types of tissue. The intensities of these pixels are formed from a combination of the different tissue types, and thus these intensities are not representative of an individual underlying tissue.
3. Intensity Inhomogeneity: Due to a variety of scanner-dependent and patient-dependent factors, the signals recorded will differ based on the spatial location within the image and patient upon which the signal is recorded. This leads to areas of the image that are darker or brighter than other areas based on their location, not based solely on the underlying tissue composition.
4. Inter-slice Intensity Variations: Some MRI protocols use a ‘multi-slice’ acquisition sequence. In these cases, the intensities between adjacent slices can vary significantly independent of the underlying tissue type.
5. Intensity Non-Standardization: MRI is not a calibrated measure, and thus the actual intensity values do not have a fixed meaning and cannot be directly compared between images.

Although some of the above problems can be overcome in the segmentation of normal structures from normal brains, when a pathology such as brain tumors and edema are present, the following additional challenges make standard methods for normal brain segmentation ineffective:
1. Intensity Overlap: Tumors and edema often have similar or the same intensity values as normal tissues, complicating detection based on intensity values.
2. Lack of a Spatial Prior Probability: Unlike normal tissues, the approximate location of a tumors and edema for an individual cannot be predicted using the average location from a group of subjects.
3. Interference with Normal Tissue: Tumors can infiltrate, displace, and destroy normal tissue. Distinguishing infiltration from normal tissue can be ambiguous, and displaced normal tissue can appear abnormal. Furthermore, the presence of tumors can cause other physiological effects such as enlargement of the ventricles.
4. Interference with model estimations: The presence of a large tumor can interfere significantly with the application of standard methods for the correction of effects such as intensity inhomogeneity, inter-slice intensity variations, and intensity non-standardization.

U.S. Pat. No. 6,430,430, issued Aug. 6, 2002 to Gosche, entitled “Method and System for Knowledge Guided Hyperintensity Detection and Volumetric Measurement” addresses a simplified version of the task of brain tumor segmentation, which is to only segment hyper-intense areas of the tumor or other abnormalities. Each step in the process involves manually chosen “knowledge-based” rules to refine the segmentation. The difficulty with the approach of Gosche is that people have difficulty describing exactly how they perform the task, so it is difficult to find a linear sequence of knowledge-based rules that correctly performs the task. Accordingly, this approach is often limited to easy to identify cases such as recognizing hyper-intensities. Another disadvantage of this type of approach is that the associated systems are often modality-dependent, task-dependent, and/or highly machine-dependent.

There are a number of other publications relating to the problem of detecting and segmenting brain tumors and associated edema in MRIs using traditional methods, including those listed below, which are incorporated herein by reference, and some of which are referred to herein.

Therefore, a need exists for an improved method and system for detecting and segmenting tumors and associated edema in MRIs.

### SUMMARY

In accordance with one aspect of the present invention, there is provided a method for segmenting objects in one or more original images, comprising: processing the one or more original images to increase intensity standardization within and between the images; aligning the images with one or more template images; extracting features from both the original and template images; and combining the features through a classification model to thereby segment the objects.

In accordance with another aspect of the present invention, there is provided in a data processing system, a method for segmenting an object represented in one or more input images, each of the one or more input images comprising a plurality of pixels, the method comprising the steps of: aligning the one or more input images with one or more corresponding template images each comprising a plurality of pixels; extracting features of each of the one or more input images and one or more template images; and classifying each pixel, or a group of pixels, in the one or more input images based on the extracted features of the one or more input images and the one or more corresponding template images in accordance with a classification model mapping image properties or features to a respective class so as to segment the object represented in the one or more input images according to the classification of each pixel or group of pixels.

In accordance with a further aspect of the present application, there is provided a data processing system for segmenting one or more input images into objects, each of the one or more input images each comprising a plurality of pixels, the data processing system comprising: a display, one or more input devices, a memory, and a processor operatively connected to the display, input devices, and memory; the memory having data and instructions stored thereon to configure the processor to: align the one or more input images with one or more corresponding template images each comprising a plurality of pixels; measure features of each of the one or more input images and one or more template images; and classify each pixel, or a group of pixels, in the one or more input images based on the extracted features of the one or more input images and the one or more corresponding template images in accordance with a classification model mapping image properties or features to a respective class so as to segment the object represented in the one or more input images according to the classification of each pixel or group of pixels.

In accordance with a further aspect of the present invention, there is provided in a data processing system, a method for segmenting an object represented in one or more images, each of the one or more images comprising a plurality of pixels, the method comprising the steps of: measuring image properties or extracting image features of the one or more images at a plurality of locations; measuring image properties or extracting image features of one or more template images at a plurality of locations corresponding to the same locations in the one or more images, each of the template images comprising a plurality of pixels; and classifying each pixel, or a group of pixels, in the one or more images based on the measured properties or extracted features of the one or more images and the one or more template images in accordance with a classification model mapping image properties or extracted features to respective classes so as to segment the object represented in the one or more images according to the classification of each pixel or group of pixels.

In accordance with further aspects of the present application, there is provided an apparatus such as a data processing system, a method for adapting this system, articles of manufacture such as a machine or computer readable medium having program instructions recorded thereon for practising the method of the application, as well as a computer data signal having program instructions recorded therein for practising the method of the application.

These and other aspects and features of the application will become apparent to persons of ordinary skill in the art upon review of the following detailed description, taken in combination with the appended drawings.

### BRIEF DESCRIPTION OF THE DRAWINGS

FIG. 1 illustrates a series of exemplary images used in detecting or segmenting brain tumors or associated edema using magnetic resonance imaging;

FIG. 2 is a block diagram of a method for automatic detection and segmentation of tumors and associated edema in magnetic resonance images in accordance with one embodiment of the present invention;

FIG. 3 are exemplary MRI images showing local noise reduction in which the top row shows the original image modalities and the bottom row shows images after edge-preserving smoothing in accordance with one embodiment of the present invention;

FIG. 4 are exemplary MRI images showing inter-slice intensity variation reduction in which the top row shows an original set of five adjacent slices after edge-preserving smoothing and the bottom row shows the same slices after correction for inter-slice intensity variations in accordance with one embodiment of the present invention;

FIG. 5 is illustrates an example of intensity inhomogeneity correction in which the top row shows a set of adjacent slices after edge-preserving smoothing and reduction of inter-slice intensity variations, the middle row shows slices after correction of intensity in homogeneity by the Nonparametric Nonuniform intensity Normalization (N3) algorithm, and the bottom row shows computed inhomogeneity fields in accordance with one embodiment of the present invention;

FIG. 6 illustrates inter-modality registration by maximization of mutual information in accordance with one embodiment of the present invention;

FIG. 7 illustrates a template registration in accordance with one embodiment of the present invention in accordance with one embodiment of the present invention;

FIG. 8 illustrates a comparison of effective linear registration and highly regularized non-linear registration;

FIG. 9 illustrates a comparison of a naive and an effective interpolation method;

FIG. 10 illustrates template-based intensity standardization in accordance with one embodiment of the present invention;

FIG. 11 illustrates examples of image-based features;

FIG. 12 illustrates examples of coordinate-based features;

FIG. 13 illustrates examples of registration-based features;

FIG. 14 is an overall block diagram of a supervised learning framework in accordance with one embodiment of the present invention;

FIG. 15 illustrates classifier output in accordance with one embodiment of the present invention;

FIG. 16 illustrates the relaxation of classification output in accordance with one embodiment of the present invention; and

FIGS. 17A and 17B is a detailed flowchart of a method for automatic detection and segmentation of tumors and associated edema in magnetic resonance images in accordance with one embodiment of the present invention.

It will be noted that throughout the appended drawings, like features are identified by like reference numerals except as otherwise indicated.

### DETAILED DESCRIPTION OF THE PREFERRED EMBODIMENTS

In the following description, numerous specific details are set forth to provide a thorough understanding of the invention. However, it is understood that the invention may be practiced without these specific details. In other instances, well-known structures and techniques have not been described or shown in detail in order not to obscure the invention.

In accordance with some embodiments of the present invention, MRI image intensities are normalized through processing of the intensity data before classification of the input images from MRI equipment. To provide additional robustness to these effects and to address the difficulties in discriminating normal from abnormal pixels, in classification features are used that represent intensity, texture, distance to normal intensities, spatial likelihood of different normal tissue types and structures, expected normal intensity, intensity in registered brain, and bi-lateral symmetry. Furthermore, these features are measured at multiple scales (e.g. single pixel and multi-pixel scales with the assistance of filters etc.) to provide a segmentation of the images that is based on regional information in addition to highly detailed local information. A supervised classification framework is used to learn a classification model, e.g. for a particular pathology such as brain tumors and associated edema (swelling), which combines the features in a manner which optimizes a performance metric, thus making effective use of the different features.

In contrast, prior art methods and systems have either used only a very narrow set of features, such as examining intensity and texture values, or examined intensity and a single registration-based or coordinate-based feature, or tried to incorporate diverse sources of evidence or prior knowledge, but resorted to manually chosen rules or operations to incorporate this information since it is non-trivial to translate this prior knowledge into an automatic method.

The present invention considers a very rich source of features, including a large variety of image-based, coordinate-based and registration-based features. Furthermore, these features provide a convenient method to represent a large amount of prior knowledge (e.g. anatomical and pathological knowledge in medical applications) at a low (and machine friendly) level, and the use of a supervised classification model allows these features to be used simultaneously and effectively in automatically detecting and segmenting tumors.

A possible advantage of encoding prior knowledge through the use of an enriched set of features is that the combination of different types of features often allows a more effective classification. For example, knowing that a pixel is asymmetric on its own is relatively useless. Even with the additional knowledge that the pixel has a high T2 signal and a low T1 signal would not allow differentiation between Cerebro-Spinal Fluid (CSF) and edema. However, consider the use of the additional information that the pixel's region has a high T2 signal and low T1 signal, that the pixel's intensities are distant in the standardized multi-spectral intensity space from CSF, that the pixel has a low probability of being CSF, that a high T2 signal is unlikely to be observed at the pixel's location, that the pixel has a significantly different intensity than the corresponding location in the template, and that the texture of the image region is not characteristic of CSF. From this additional information, is more likely that the pixel represents edema rather than CSF. This additional information adds robustness to the classification model since each of the features can be simultaneously considered and combined in classifying a pixel as normal or abnormal (e.g. tumor).

From the elements of the system described below, it will be appreciated that there can be considerable variation in the implementation details. For example, different methods could be substituted for each of the steps, certain steps could be added or removed, and different permutations in the ordering of the steps could be used. The capability of representing prior knowledge through low-level features that extends beyond image data may also be incorporated into other existing methods to perform this (or a related) task.

There are relatively few assumptions made about the input data, making this system readily adaptable to related tasks, while the overall concept is easily translated to related tasks. For example, a specific definition of abnormality has not been chosen, since the system can learn to use the features to recognize different types of abnormalities by simply changing the labels of the training data. Although different definitions of abnormality based on tumor-related tasks (enhancing tumor areas, gross tumor areas, edema areas) have been explored, the class labels may be changed such that the system could be used to segment other types of abnormalities (such multiple sclerosis lesions, areas of stroke or brain damage, and other types of lesions), or the segmentation of normal structures.

The lack of assumptions about the input data additionally means that the system does not depend on the image modalities used. Although T1-weighted and T2-weighted images were used, the system could learn to use different sets of modalities, including more advanced modalities such as Magnetic Resonance Spectroscopy, which would likely lead to much more accurate results.

The steps of employing template registration and incorporating prior knowledge through low-level features is not limited to the segmentation of brain tumors. Templates and standard coordinate systems exist or may be made for other areas of the body for which the principles described in the present application may then be adapted.

The present invention seeks to provide several advantages. Since there is no widely used automatic methods to accurately segment tumors in trivial cases (i.e., not fully enhancing), the method of the present invention may be used to replace or at least complement existing widely used semi-automatic methods to perform this task. This would result in reduced costs of the method and system compared to highly paid medical experts performing this task manually, a standard method to perform segmentation that would not have the drawback of human variability (being able to detect smaller changes), and the ability to segment large amounts of historical data at no cost.

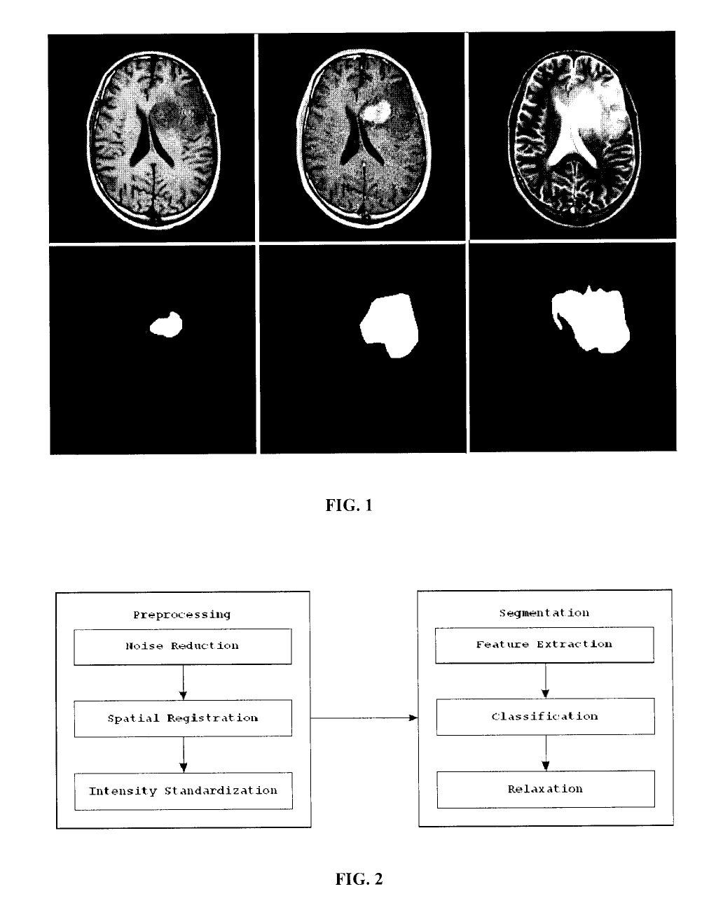

According to one embodiment, the present invention provides the aspects of a method and system for the automatic detection and segmentation of tumors (e.g., brain tumors) or associated edema from a set of multi-spectral Magnetic Resonance Imaging (MRI) images. Using a set of unlabelled images of the head, a label is attached to each pixel within the images as either a “normal” pixel or a “tumor/edema” pixel. This is illustrated in FIG. 1 (note that only a two-dimensional cross-section of a three-dimensional volume is shown). The top row shown in FIG. 1 represents the input to the system (multi-spectral MRI), while the bottom row represents three different tasks that the system can be used to perform (the segmentation of the metabolically active enhancing tumor region, the gross tumor including non-enhancing areas, and the edema area).

According to another aspect of the present invention, there is provided a data processing system (not shown) adapted for implementing an embodiment of the invention. The data processing system includes an input device, a processor or central processing unit (i.e. a microprocessor), memory, a display, and an interface. The input device may include a keyboard, mouse, trackball, remote control, or other suitable input device. The CPU may include dedicated coprocessors and memory devices. The memory may include RAM, ROM, or disk devices. The display may include a computer screen, terminal device, or a hardcopy producing output device such as a printer or plotter. The interface may include a network connection including an Internet connection and a MRI system connection.

The data processing system may include a database system for storing and accessing programming information and MRI images. The database system may include a database management system (DBMS) and a database and is stored in the memory of the data processing system. Alternatively, the MRI images may be received from the MRI system through the data processing system's interface.

The data processing system includes computer executable programmed instructions for directing the system to implement the embodiments of the present invention. The programmed instructions may be embodied in one or more software modules resident in the memory of the data processing system. Alternatively, the programmed instructions may be embodied on a computer readable medium (such as a CD, floppy disk, flash drive etc.) which may be used for transporting the programmed instructions to the memory of the data processing system. Alternatively, the programmed instructions may be embedded in a computer-readable, signal-bearing medium that is uploaded to a network by a vendor or supplier of the programmed instructions, and this signal-bearing medium may be downloaded through the interface to the data processing system from the network by end users or potential buyers.

At an abstract level, the presents invention comprises the following steps or components:
1. Pre-processing of the intensity data to increase standardization of the intensities within and between input images;
2. The alignment or registration of the input images with one or more template images (e.g. template brains) in a standard coordinate system (which may have known properties)—the input images may be aligned onto the template images or vice versa;
3. Extraction of features at the pixel and multi-pixel level from both the input and template images; and
4. Classification of each pixel (e.g. as “normal” or “abnormal”) of the input images using a classification model that compares the extracted features of the input images to those of the template images in accordance with the classification model

At a less abstract level, these steps components can be further subdivided as follows:

1. Image Intensity Pre-Processing:
(a) Local Noise Reduction: Processing which directly reduction of the effects of local noise and therefore increases standardization of intensities within local image areas;
(b) Inter-slice Intensity Variation Reduction: Processing which directly reduces the effects of inter-slice intensity variations and therefore increases standardization of the intensities across slices within the volume;
(c) Intensity Inhomogeneity Reduction: Processing which directly reduces the effects of intensity inhomogeneity, used to increase standardization of the intensities within the volume; and
(d) Intensity Standardization: Processing which directly reduces the effects of intensity non-standardization, used to increase standardization of the intensities between volumes.

2. Registration:
(a) Coregistration: The spatial alignment of the different image modalities of the same patient;
(b) Linear Template Registration: The spatial alignment of the volumes with a template in a standard coordinate system, required in order to use measurements based on the coordinate system;
(c) Non-Linear Template Registration: Warping of the volumes to more closely correspond to one or more template images, this can improve the utility of features based on the registration by accounting for minor anatomic variations and global differences in head shape; and
(d) Spatial Interpolation: Resampling of the volume ‘grid’ such that pixels in the spatially transformed volumes have the same size and spatially correspond to template pixels in the standard coordinate system.

3. Feature Extraction:
(a) Image-based Features: The extraction of features based on the image data, potentially including intensity features, texture features, histogram-based features, and shape-based features;
(b) Coordinate-based Features: The extraction of features based on the registration to a standard coordinate system, potentially including coordinates features, spatial prior probabilities for structures or tissue types in the coordinate system, and local measures of anatomic variability within the coordinate system;
(c) Registration-based Features: The extraction of features based on known properties of the one or more aligned templates, potentially including features based on labelled regions in the template, image-based features at corresponding locations in the template, features derived from the warping field, and features derived from the use of the template's known line of symmetry.

4. Classification and Relaxation:
(a) Feature Processing: Before classification, the extracted feature set can be refined to make it more appropriate for achieving high classification accuracies;
(b) Classifier Training: Pixels that are labelled as normal and abnormal are used with the extracted features to automatically learn a classification model that predicts labels based on the features;
(c) Pixel Classification: The learned classification model can then be used to predict the labels for pixels with unassigned labels, based on their extracted features; and
(d) Relaxation: Since the learned classification model may be noisy, a relaxation of the classification results which takes into account dependencies in the labels (i.e. classification) of neighbouring pixels can be used to refine the classification predictions and yield a final segmentation.

### Overview

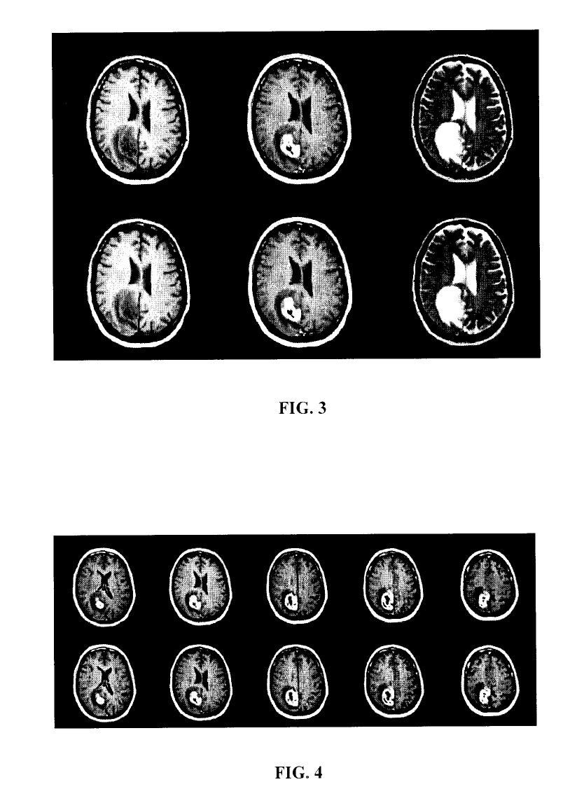

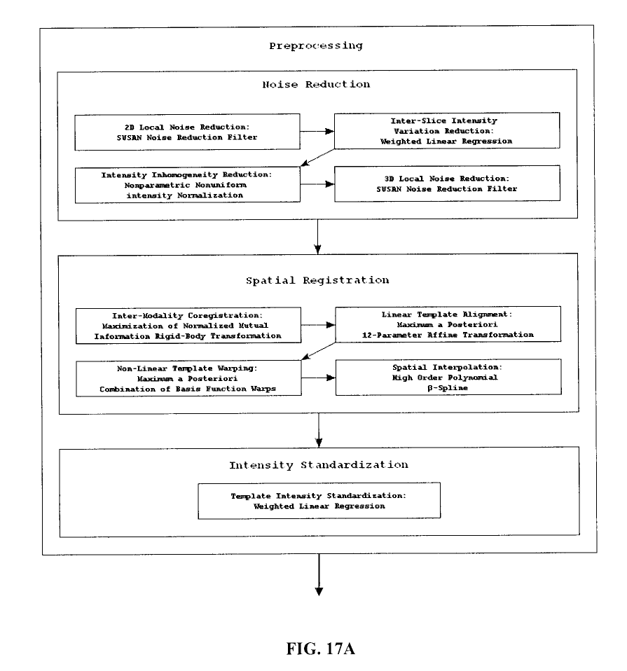

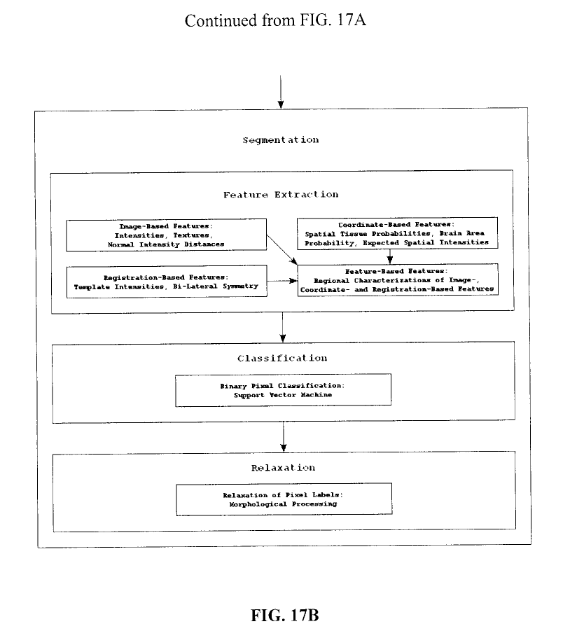

An overview of one embodiment of an implemented system for segmenting an object represented in one or more input images (i.e. images) will now be described. As shown in FIGS. 2, 17A-17B, the method and system can be separated into two stages: pre-processing and segmentation. The processing stage comprises three main steps or components: image intensity inhomogeneity reduction (or “noise” reduction) within and between the input images, spatial registration, and intensity standardization. The segmentation stage comprise three main steps or components: feature extraction; classification; and relaxation. The system may receive as input one or more images generated by a magnetic resonance imaging procedure or medical imaging procedure (e.g. MRI images of some modality).

Noise reduction comprises the following steps or components: 2D local noise reduction within the input images; inter-slice intensity variation reduction comprising reducing intensity variations between adjacent images in an image series formed by the input images; intensity inhomogeneity reduction for reducing gradual intensity changes over the image series; and 3D local noise reduction comprising reducing local noise between over the image series. In other embodiments, image intensity pre-processing may not be performed, for example where the image pre-processing happens separately (e.g. at the MRI equipment) or may not be needed if the MRI equipment produces suitable output images/data.

Spatial registration comprises the following steps or components: inter-modality co-registration; linear template alignment; non-linear template warping; and spatial interpolation. Co-registration generally refers to aligning different images of the same object (e.g. same patient in medical applications) which may be taken at the same or different times, and may be of the same or different modality. Linear template alignment or registration aligns the input images with corresponding template images (e.g. template brains) in a standard coordinate system (which may have known properties—see coordinate-based features discussed below)—the input images may be aligned onto the template images or vice versa. Non-linear template registration (or warping) spatially transforms the input images to increase correspondence in shape of the input images to the template images. This may adjust the shape of the object within the input images, and in some applications adjusts the shape of the object in a series of two-dimensional images to warp the volume represented by the input image series to more closely correspond to the volume of the template object in the template image series (it will be appreciated that a three-dimensional object may be represented by a series of two-dimensional images (e.g. cross-sectional images) taken in a common plane that are offset with respect to one another so as to represent a volume (e.g. offset along a common axis at a known or determinable distance). This can improve the utility of features based on the registration or alignment with the template images by accounting for minor variations and global differences in shape (e.g. minor anatomic variations and global differences in head shape).

Spatial interpolation adjusts the pixels in the spatially transformed images (or volumes) so as to have the same size and spatially correspond to template pixels in the template images according to the standard coordinate system.

In the intensity standardization of the input images, the intensity of the input images may be standardized relative to the template image intensities. Alternatively, the intensity of the input images may be standardized according to a joint intensity standardization that determines an intensity adjustment for each input image that maximizes a measured similarity between the input images, in which case no template is needed.

In the segmentation stage, feature extraction comprises one or more of image-based feature extraction; coordinate-based feature extraction; registration-based feature extraction; and feature selection. Preferably, all of image-based features, coordinate-based features and registration-based features are extracted. The extracted features may be a directly measured feature or derived from a measured feature (indirect). Image-based features are based on measurable properties of the input images or corresponding data signals (such as intensity, brightness, contrast etc.—it may any measurable image property or parameter that is considered to be important). Coordinate-based features are based on measurable properties of a known coordinate reference system or corresponding data signal. The coordinate reference system is a reference or standard for comparison wherein the value of the various properties at a given location corresponds to a reference standard which is typically a statistical measure, such as the average value, for the properties at this location over a given data set (e.g. historical data). Coordinate-based features generally represent the average value of the properties at a given position in the standard coordinate system. Registration-based features are based on measurable properties of the template images or corresponding data signals.

In a given system implementation, the measurable properties selected are the same for each of the one or more image-based, coordinate-based and registration-based features that are extracted. The image-based, coordinate-based and registration-based features may be measured at single or multi-pixel level, depending on the embodiment. The extracted features can be defined in terms of a numeric value, vectors/matrices, or categorically, depending on the implementation.

Classification comprises determining a class or label for each pixel based on the extracted features in accordance with a classification model. The classification model is a mathematical model that relates or “maps” features to class. Using the extracted features, the classification model assigns individual data instances (e.g. pixels) a class label among a set of possible class labels. Although binary classification is frequently discussed in this application and is used when classifying pixels as being “normal” or “abnormal” as in medical diagnostic applications, the classification model need not be binary. In non-binary classification systems, each pixel is classified as belong to one of 3 or more classes.

Relaxation comprises the relaxation (or “reclassifying”) of pixel labels (i.e. pixel classifications) in a manner that takes into account the classification of surrounding (e.g. “neighbouring”) pixels. For example, relaxation may take into account higher order image features or multi-pixel features which may not be detectable at the single pixel level. Relaxation techniques, sometimes called relaxation labelling techniques, are well known in the art of computer vision. Many different relaxation techniques may be implemented, some of which are described in this application.

Relaxation involves refining the probabilistic estimates (that a pixel belongs to a particular class) or labels of each pixel using spatial or structural dependencies in the classification and/or features of the surrounding pixels which may not be detected at the single pixel level.

Since the learned classification model may be noisy (for example it may not smoothly separate pixels by class according to their extracted features) a relaxation of the classification results which takes into account dependencies in the classification of the surrounding pixels may refine the classification predictions and yield an improved segmentation.

Relaxation typically involves smoothing of the pixel labels, the selection of clusters or connected components, minimizing active contour energy models, and/or minimizing random field energy models. Each of these can potentially utilize any/all labels in the image (not just surrounding pixels). In addition, it may be possible to take into account the features or assess properties of the resulting structures when performing relaxation.

The classification process will now be explained in more detail.

In the classification process, the extracted features are compared with the classification model. The classification model provides a mathematical model that correlates or maps extracted features to the classes defined by the model (e.g., “normal” or abnormal” in certain medical diagnostic applications, however different classes may be defined, and the classes may be greater than two in number).

An example will now be given to further illustrate the classification process. Consider a pixel to be classified in an image at a location having three-dimensional coordinates of {X=132, Y=155, Z=50}. The three-dimensional coordinates may be obtained by a series of two-dimensional images, for example a series of vertical slices where each two-dimensional image defines a horizontal plane defined by the coordinates X and Y, and the vertical coordinate Z is provided by an offset between the vertical slices of known or determinable size.

In the first step, the image information (i.e. image-based features) about the pixel location in an input image is measured. For example, the image at this location may be measured in terms of two parameters, such as brightness and contrast. The pixel measurement at this location may be [0.5, 0.4] in terms of [brightness, contrast].

In the next step, the location {X=132, Y=155, Z=50} in a known coordinate reference system is measured for these same parameters (i.e. coordinate-based features). The pixel measurement at this location may be [0.3, 0.2]. The value of the coordinate-based feature presents a statistical measure (e.g. average value) of this pixel at this location over a given data set (e.g. historical data set)—not to be confused with the value of the corresponding template image at this location.

In the next step, the template-image aligned or registered with the input image is examined at the same location {X=132, Y=155, Z=50}, and measurements for the brightness and contrast parameters are taken. The pixel measurement at this location may be [0.9 0.1].

The combination of the measure features gives a so-called “feature vector” for the pixel:

[f1=0.5, f2=0.4, f=0.3, f4=0.2, f5=0.9, f6=0.1]

The process continues until feature vectors are defined for each pixel in the input image. The feature vector of each pixel is then compared against the classification model and a classification (i.e. label) for the feature vector representing each pixel is determined. In some cases, the feature vector may be input into the classification model which returns the class. Formulaically, the class may be represented by a number value or sign which, in turn, can be translated into a classification or label having some meaning to a user of the system, for example “normal” or “abnormal” (which may be represented numerically as −1 and 1, respectively).

Before analysing or segmenting an image using the classification model, the classification model must be learned by, or taught to, the system. In the “learning” or “classifier training” phase, the classification model is given a training set of data comprising a set of feature vectors and a corresponding class label assigned to each training feature vector (i.e., either −1 or 1 for each feature vector). A mathematical model is then generated which correlates or maps the feature vectors to the class labels. Thus, the output of the learning phase is a classification model (i.e. a mathematical model) that given a feature vector can return a classification (i.e. either −1 or 1) according to its mapping. The complexity of the relationship between feature vectors and class that is defined by the classification model will vary depending on the amount of training data, the size of the respective feature vectors, and the inherent correlation between the individual features and the class among other features.

There are many ways to learn a classification model, some of which are described in this document. A relatively simple classification procedure method that may be used is the “linear discriminant” technique. Many different techniques for learning classification models of varying complexity are known in the art of machine learning, some of which are described in more detail below. The form that these classifiers take is as follows (where “prediction” is equivalent to “classification”—the result of the equation being an indirect assessment of the probability that the pixel belongs in one class over another based on measured feature vectors):

prediction=w1*f1+w2*f2+w3*f+w4*f4+w5*f5+w6*f6+w0*1

label=sign (prediction)

Using this technique, the learning phase generally consists of finding a set of values for coefficients {w1, w2, w3, w4, w5, w6, w0} such that the sign of these variables multiplied element-wise by the measured features gives the correct class labels. Thus, the computed features are identical between the classes, but the classification model finds a way to use the features that maps onto class labels. Accordingly, classification based on a “linear discriminant” model involves taking the sign of the (vector) product of features with learned coefficients.

Although brightness and contrast are described in the foregoing example, it will be appreciated that any measurable image features or properties that are believed to be important can be selected for measurement (extraction) provided the classification model has learned to map the selected features to the corresponding classes. Thus, the actual image parameters that are measured/extracted may vary between classification models (or “classifiers”).

Typically, the classification model considers all extracted features simultaneously however this is not necessarily the case. For example, some classification models may only examine image-based features and registration-based features without regard to coordinate-based features.

Although classification has been discussed as occurring on pixels individually, many classification methods are able to perform joint labelling (this can effectively combine classification with relaxation).

As an output of the system, the segmentation of the image into objects according to class may be displayed via a visual representation such as an output image presented on the display of a data processing system or other device on which the input images were segmented. This may involve colour-coding the pixels in the input images in accordance with its respective classification or otherwise marking the pixels in the images. For example, pixels may be outlined or delineated in accordance with their respective classification. Alternatively, the pixel classification may be stored in a data table or database, etc. in a data store or memory, or may be provided in an output signal, for example for subsequent processing.

In a preferred embodiment of a system for the automatic detection and segmentation of tumors and associated edema (swelling) in MRI images according to the present invention, the system follows a linear sequence of operations shown in FIGS. 2 and 17A-17B. The components of the system will be described in more detail below. The input to the process is a set of images. The process, which is implemented by the system, begins with the step of noise reduction and ends with the step of relaxation. The output is a labelling of each pixel in the input images as either “normal” or “abnormal”, depending on the definition of abnormality used.

### Pre-Processing

### Noise Reduction

### 2D Local Noise Reduction

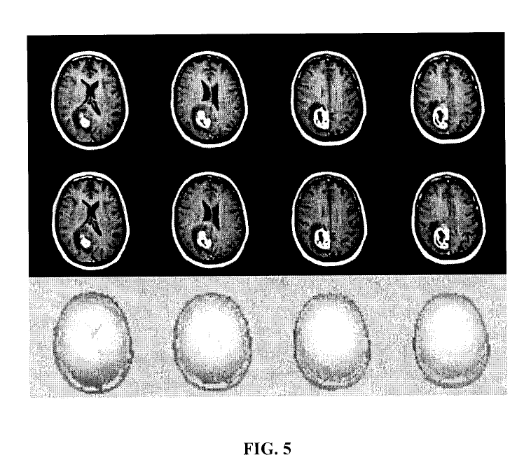

The first processing step is the reduction of local noise within each slice to increase standardization of the intensities within local image regions. An effective class of methods for performing this task are edge-preserving smoothing methods. One method that may be used is the SUSAN Noise Reduction method of [Smith and Brady, 1997] since it is effective at reducing the effects of local noise without degrading fine image details. This non-linear filter is applied to each two-dimensional slice in each of the input volumes, and the filter responses are input to the next processing stage. FIG. 3 shows exemplary MRI images showing local noise reduction in which the top row shows the original image modalities and the bottom row shows images after edge-preserving smoothing.

### Inter-Slice Intensity Variation Reduction

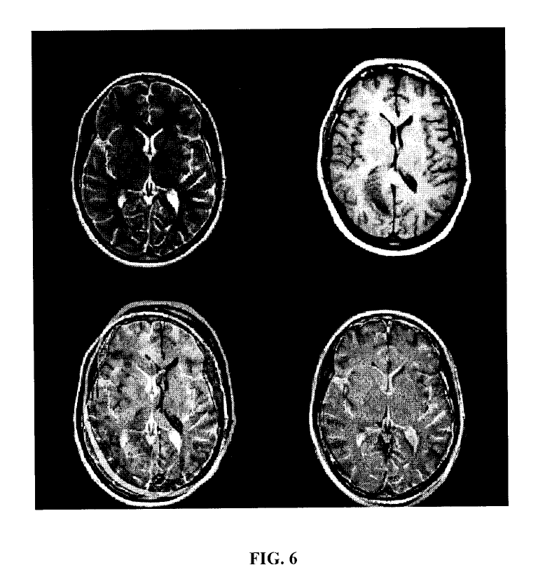

Reference will now be made to FIG. 4 which shows exemplary MRI images showing inter-slice intensity variation reduction in which the top row shows an original set of five adjacent slices after edge-preserving smoothing (note the increased brightness of the second and fourth slice) and the bottom row shows the same slices after correction for inter-slice intensity variations. After local noise reduction, the slices in each modality are then processed to reduce the effects of inter-slice intensity variations. This increases standardization of the intensities between adjacent slices of the same volume. Cost-sensitive linear regression (see [Moler, 2002]) was used to estimate a multiplicative intensity scaling factor between the foreground areas of adjacent slices that minimized square error of the intensity difference between corresponding pixels in adjacent slices. This method of estimates the mapping to the median slice from each adjacent slice, and then proceeds outwards from the median slice to estimate the mapping from other slices. Since the same tissue types will not be aligned at all locations in adjacent slices, the ‘cost’ of the error for differences in intensities at corresponding pixels in adjacent slices was computed based on the local image joint entropy, and the absolute difference in intensities between the adjacent pixel. The use of this cost function puts increased emphasis in the regression on pixels that are likely to represent the same tissue type in adjacent slices, making the method robust to areas where identical tissue types are likely not aligned.

### Intensity Inhomogeneity Reduction

Reference will now be made to FIG. 5 which illustrates an example of intensity inhomogeneity correction in which the top row shows a set of adjacent slices after edge-preserving smoothing and reduction of inter-slice intensity variations, the middle row shows slices after correction of intensity in homogeneity by the Non-uniform intensity Normalization (N3) method of [Sled, 1997] and [Sled et al., 1999], and the bottom row shows computed inhomogeneity fields (note that pixels below an intensity threshold are not used in estimating the field).

After the reduction of inter-slice intensity variations, the intensities within image volumes are further standardized through the use of an intensity inhomogeneity reduction algorithm. The Non-parametric Nonuniform intensity Normalization (N3) method of [Sled, 1997] was used. This method has been shown to be one of the most effective methods in an important study [Arnold et al., 2001]. This method assumes a Gaussian distribution of inhomogeneity field values, and uses deconvolution of the histogram with this distribution to ‘sharpen’ high frequency components of the image histogram. The computed field estimates are smoothed through the use of B-splines which makes the technique more resistant to noise and produces a slowly varying spatial inhomogeneity field used to correct the images for inhomogeneity effects.

### 3D Local Noise Reduction

To further standardize the intensities within image volumes, a 3D version of the SUSAN Noise Reduction filter is applied to the inhomogeneity corrected volumes.

### Spatial Registration

### Inter-Modality Co-Registration

To determine the spatial mapping between images of different modalities, a 6-parameter rigid-body (translation and rotation in 3 dimensions) transformation is found that maximizes the Normalized Mutual Information criteria presented in [Studholme et al., 1998]. The implementation from [SPM, Online] is used, that uses this criteria, and searches for the optimal parameters using a method based on the work in [Collignon et al., 1995]. The use of a mutual information based measure allows the registration of a large variety of possible imaging modalities.

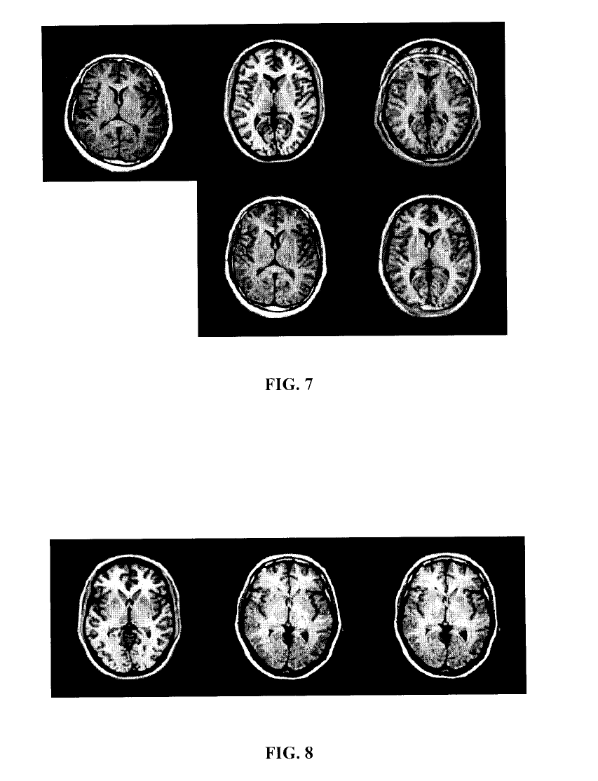

FIG. 6 illustrates inter-modality registration by maximization of mutual information. The top left images shows a T2-weighted image from individual A. The top right shows a T1-weighted image individual B. The bottom left shows a T1-weighted image from individual B overlayed on T2-weighted image from individual A before registration. The bottom right shows a T1-weighted image from individual B overlayed on T2-weighted image from individual A after registration by maximization of mutual information.

### Linear Template Alignment/Linear Template Registration

To determine the spatial mapping between the images of the patient to be segmented and a template in a standard coordinate system, a maximum a posteriori (MAP) 12-parameter (translation, rotation, scaling, and shearing in 3 dimensions) linear affine transformation is found using the method of [Friston et al., 1995, Ashburner et al., 1997]. This method assesses the registration using the squared intensity difference measure, using empirically determined prior probabilities for the 12 parameters to speed convergence and increase robustness. The spatial transformation parameters are determined using the same modality as the template, and are used to transform the other (co-registered) modalities.

FIG. 7 illustrates a template registration. The top row shows, moving left to right: a T1-weighted image; a T1-weighted template [Holmes et al., 1998]; and a T1-weighted image overlayed on T1-weighted template. The bottom row shows, moving left to right: a T1-weighted image after spatial registration with T1-weighted template; and a registered T1-weighted image overlayed on T1-weighted template.

### Non-Linear Template Registration (Warping)

A non-linear registration method is used to refine the template registration step, which increases correspondence between the images and template by correcting for overall differences in head shape and minor anatomic variations. One method that may be used is the method of [Ashburner and Friston, 1999], which has been shown to highly effective [Hellier et al., 2002] at the non-linear registration of images of the brain. This method also finds a maximum a posteriori solution minimizing squared intensity difference, but uses the smoothness of the deformation field instead of empirical prior probabilities for regularization.

FIG. 8 illustrates a comparison of effective linear registration and highly regularized non-linear registration. The left image shows a T1-weighted template [Holmes et al., 1998]; the middle image shows a T1-weighted image after linear 12-parameter affine registration to T1-weighted template; and the right image shows a T1-weighted image after further heavily regularized non-linear registration. Although the difference is subtle, the overall correspondence with the template has been increased due to small corrections for overall head and brain shape. It also noteworthy that the non-linearly registered image is more symmetric.

### Spatial Interpolation

After the three spatial transformations have each been applied, the images are re-sampled such that pixels in the image have the same size and locations as pixels in the template. This is done using an implementation of the fast B-spline interpolation algorithm originally proposed in [Unser et al., 1991], which has proved to be an accurate and computationally efficient interpolation strategy (see [Meijering, 2002]).

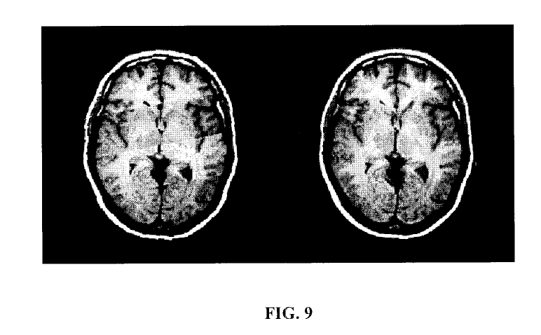

FIG. 9 illustrates a comparison of a naive and an effective interpolation method. The left image shows nearest neighbor spatial interpolation after template registration, and the right image shows high degree polynomial β-spline interpolation from the same original data and transformation. It is noteworthy that this volume was not corrected for inter-slice intensity variations, which are clearly visible in the left image (although they can be seen to a lesser extent in the right image).

### Intensity Standardization

The intensity template used in spatial registration is also used as a template for intensity standardization. Intensity standardization is also performed as a cost-sensitive linear regression, with several distinctions from the inter-slice intensity variation reduction algorithm. Since the brain area in the template is known, incorporated into the cost function is the likelihood that pixels are part of the brain, since it is more important to focus on standardizing these pixels compared to pixels outside the brain. Additionally, since the template does not contain large tumors or edema regions, this must be taken into account. A measure of symmetry is incorporated into the cost function such that symmetric (and therefore more likely normal) regions are given more weight in estimation than non-symmetric (and therefore more likely to be abnormal) regions.

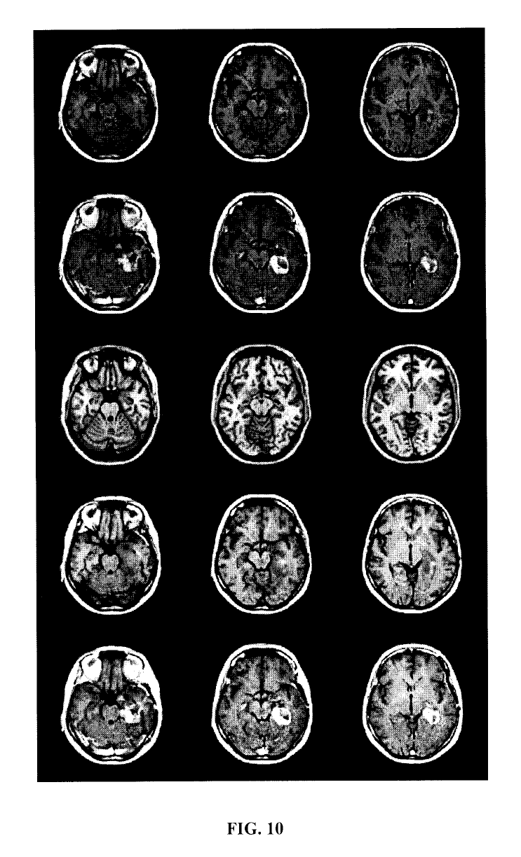

FIG. 10 illustrates template-based intensity standardization. The first row shows T1-weighted images after noise reduction and spatial registration. The second row shows T1-weighted post-contrast injection images after noise reduction and spatial registration. The third row shows T1-weighted template used for standardization. The fourth row shows T-1 weighted images after intensity standardization. The fifth row shows T1-weighted post-contrast injection images after intensity standardization. It will be appreciated that the intensity differences between similar tissue types have been decreased significantly.

### Segmentation

### Feature Extraction

### Image-Based Features

The main image-based features used are the (standardized) intensities. To take into account neighbourhood information at different scales and characterize local image textural properties, the responses of linear filters of the images as features rather than using the intensities directly were employed. These included Gaussian filters of different sizes, Laplacian of Gaussian filters of different sizes, and the Maximum Response Gabor filters of [Varma and Zisserman, 2002]. As an additional image-based feature, the multi-channel Euclidean distance for each pixel's intensity to the average intensities of the 3 normal tissue types was incorporated in the template brain. These features thus measure how far a pixel's multi-channel intensities differ from the intensities of normal tissues in the brain, and thus can represent important features for tumor recognition (since these 3 distances will likely be larger than normal). This feature was incorporated at multiple scales through linear filtering with different sized Gaussian kernels.

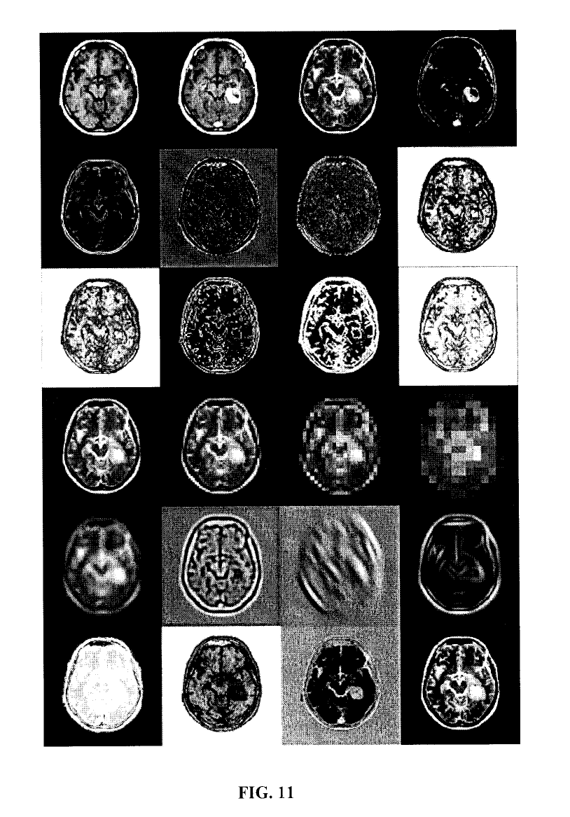

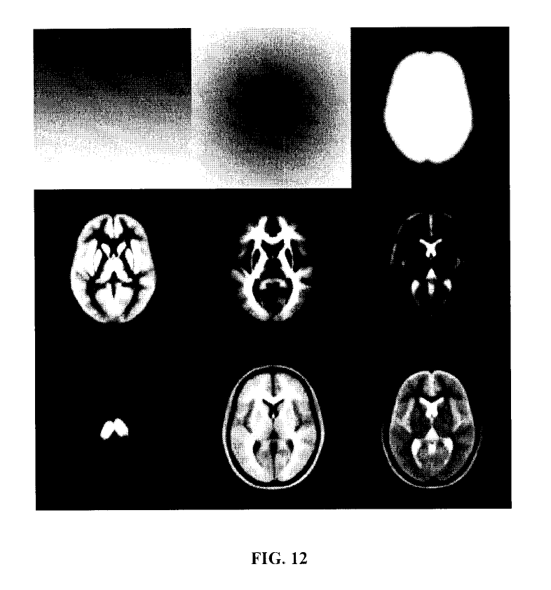

FIG. 11 illustrates examples of image-based features: The first row shows intensity standardized intensities, moving left to right, in a T1-weighted, T1-weighted post-contrast injection, T2-weighted and contrast difference images respectively. The second row shows first order textures of a T2 image, moving left to right: variance, skewness, kurtosis, energy. The third row shows second order textures of a T2 image, moving left to right: angular second momentum, cluster shade, inertia, and local homogeneity. The fourth row shows four levels of a multi-resolution Gaussian pyramid of the T2 image. The fifth row shows linear filtering outputs from the T2 image, moving left to right: Gaussian filter output, Laplacian of Gaussian filter output. Gabor filter output, and maximum response Gabor filter output. The sixth row shows, moving left to right: T2 intensity percentile, multi-spectral (log) intensity density within the image, multi-spectral distance to the templates average white matter intensities, and unsupervised segmentation of the T2 image.

### Coordinate-Based Features

For coordinate-based features, the ‘tissue probability models’ may be used for the three normal tissue types in the brain from [ICBM View, Online]. This measures, for each pixel in the coordinate system, the likelihood that it would belong a priori to each of these three normal classes (if the brain was normal). This can be useful features for tumor recognition since normal intensities at unlikely locations could potentially represent abnormalities. The ‘brain mask’ prior probability from [SPM, Online] may also be used, which represents a similar measure, but represents the probability that each pixel in the coordinate system is part of the brain area (important since the classifier can then easily learn to not label pixels outside of the brain). As another set of coordinate-based features, the average intensities over 152 normal individuals registered into the coordinate system obtained from [ICBM View, Online] may be used. These serve a similar purpose as the tissue probability models, since an unexpected intensity at a location can be an indication of abnormality. Each of the coordinate-based features is incorporated at multiple scales through linear filtering with different sized Gaussian kernels.

FIG. 12 illustrates examples of coordinate-based features: The first row shows, moving left to right: y-coordinate, distance to image center, and brain mask prior probability [SPM, Online]. The second row shows, moving left to right: gray matter prior probability, white matter probability, and CSF (Cerebro-Spinal Fluid) prior probability [ICBM View, Online]. The bottom row shows, moving left to right: thalamus prior probability [Mazziotta et al., 2001], average T1 intensity from a population [ICBM View, Online], and average T2 intensity from a population [ICBM View, Online].

### Registration-Based Features

The first set of registration-based features used was the registration template intensities at the corresponding pixel location. The intuition behind this feature is that pixels that have similar intensity values to the same region in the aligned template are likely normal, while differences could indicate abnormality. The second set of registration based features took advantage of the template's known line of symmetry to assess regional bi-lateral symmetry. This line of symmetry may be used to compute the difference between a pixel's intensity and the intensity of the corresponding contra-lateral pixel. Since tumors will tend to be asymmetric while normal tissues are much more symmetric, this represents an important feature. Each of the registration-based features is also incorporated at multiple scales through linear filtering with different sized Gaussian kernels.

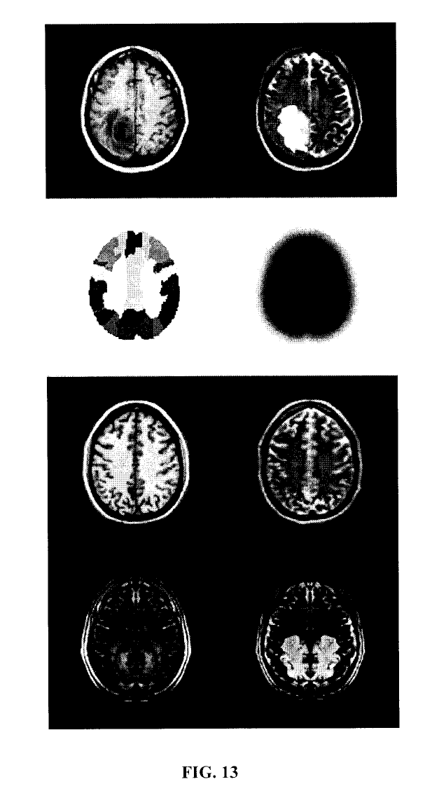

FIG. 13 illustrates examples of registration-based features. The first row shows, moving left to right, standardized and registered image data for visual comparison. The second row shows, moving left to right, labels of normal structures in the template [Tzourio-Mazoyer and et al, 2002], and distance to template brain area. The third row shows template image data at corresponding locations (note the much higher similarity between normal image regions than abnormal regions). The fourth row shows: symmetry of the T1-weighted (left) and T2-weighted (right) image by using the templates known line of symmetry.

### Feature Selection

The feature selection used in the example embodiment was primarily through the designer's intuition of what would represent an appropriate feature, and experimentation with different types of feature set. Thus, although no explicit automatic feature selection was incorporated, it should be noted that only features that performed well were included, and that automatic methods would likely improve results.

### Classification

### Classifier Training

A Support Vector Machine classifier is used, employing the method of [Joachims, 1999] to efficiently solve the large quadratic programming problem. This method trains using labelled training data, and finds the linear separator between the normal and abnormal classes, based on a kernel-defined transformation of the features, which maximizes the distance to both classes, and thus should achieve high classification accuracy.

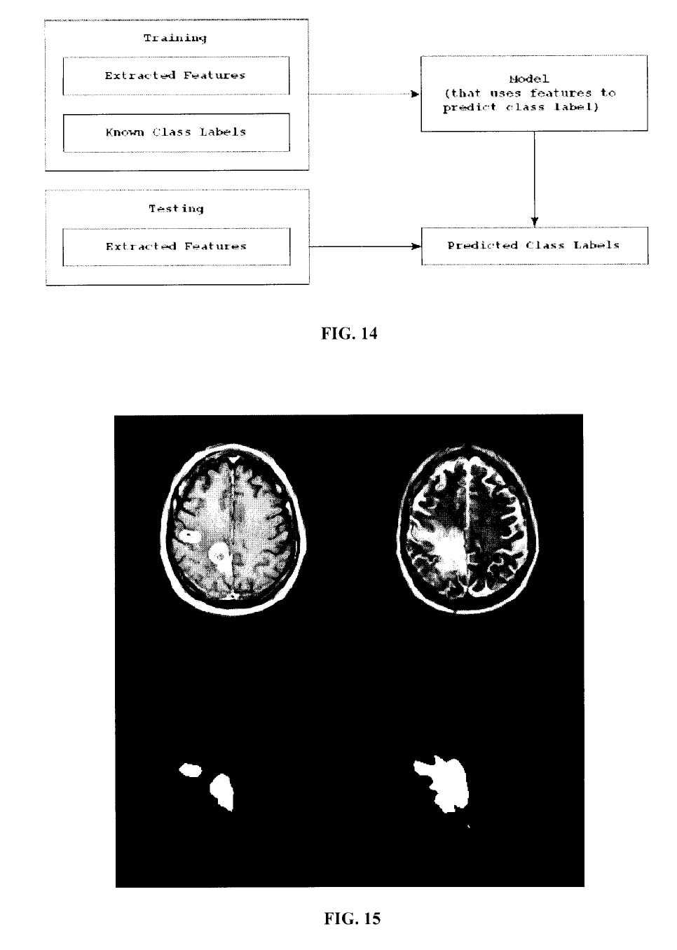

FIG. 14 is an overall block diagram of a supervised learning framework. The training phase uses extracted features and labelled to data to generate a model mapping from features to labels. The testing phase uses this model to predict labels from extracted features where the label in now known.

### Pixel Classification

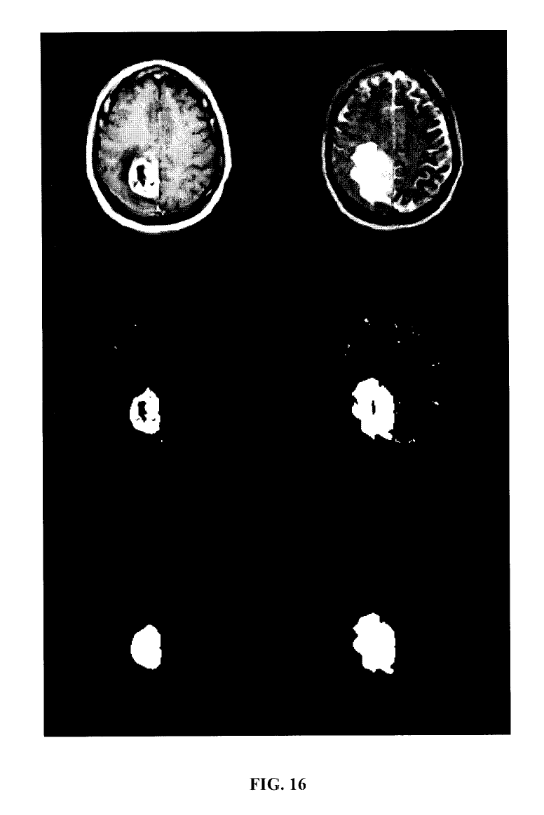

Reference will now be made to FIG. 15. The discriminant learned in classifier training is used to classify new images, where the labels are not given to the algorithm. This stage thus uses the features to assign each pixel the label of either ‘normal’ or ‘abnormal’.

FIG. 15 illustrates the classifier output. The top row shows T1-weighted post-contrast injection (left) and T2-weighed image (right). The bottom row shows: Classifier predictions for ‘Enhancing class and ‘Edema class.

### Relaxation

Reference will now be made to FIG. 16. The relaxation phase uses spatial information to correct potential mistakes made by the classifier using spatial information. A spatial median filter may be iterated over the discrete class label predictions to make labels consistent with their neighbors (terminating when no labels were changed by this filter). This was followed by a morphological ‘hole filling’ algorithm to reassign normal areas that are completely surrounded by abnormal areas. Thus, relaxation reclassifies pixels in accordance with the classification of surrounding pixels such that each pixel classification is more consistent with surrounding pixels. For example, relaxation may take into account higher order image features or multi-pixel features which may not be detectable at the single pixel level.

Relaxation involves refining the probabilistic estimates (that a pixel belongs to a particular class) or labels of each pixel using spatial or structural dependencies in the classification and/or features of the surrounding pixels which may not be detected at the single pixel level.

FIG. 16 illustrates the relaxation of classification output. The top row shows image data. The middle row shows an example of predictions made by a noisy classifier. The bottom row shows the noisy classifier output relaxed using morphological operations that take into account the labels of neighboring and connected pixels.

### Details of One Example Embodiment

One example embodiment of a system for the automatic detection and segmentation of objects in one or more original images according to the present invention will now be described in further detail along with alternatives considered for the various steps/components. The system is preferably used for the automatic detection and segmentation of tumors and associated edema (swelling) in MRI images.

### Noise Reduction

The noise reduction stage in the example embodiment comprises four steps: two-dimensional (2D) local noise reduction, inter-slice intensity variation correction, intensity inhomogeneity correction, and three-dimensional (3D) local noise reduction. The methods used follow the guidelines that they do not require a tissue model or segmentation, and perform only a small degree of correction to prevent the introduction of additional noise rather than attempting to determine an optimal correction.

### Local Noise Reduction

The first step is the reduction of local noise from the input images. There exists a multitude of methods for reducing the effects of local noise from images. [Smith and Brady, 1997] survey a diverse variety of techniques to perform this task, and a small subset were examined. The main assumption underlying most local noise reduction techniques is that noise at a specific pixel location can be reduced by examining the values of neighboring pixels. Although the algorithms are discussed with respect to two dimensional image data, each has a trivial extension to three dimensions.

A simple method of noise reduction is mean filtering. In mean filtering, noise is reduced by replacing each pixel's intensity value with the mean of its neighbors, with its neighbors being defined by a square window centered at the pixel. A more popular method of noise reduction is through Gaussian filtering. This method is similar to mean filtering, but uses a weighted mean. The weights are determined by a radially symmetric spatial Gaussian function, weighing pixels proportional to their distance from the center pixel.

Linear filtering methods such as mean filtering and Gaussian filtering unquestionably remove local noise through the use of neighborhood averaging. However, high-pass information is lost, due to averaging across edges. Median filtering is an alternative to linear methods. A Median filter replaces each pixel's intensity value with the median intensity value in its neighborhood. In addition to incorporating only intensities that were observed in the original image, median filtering does not blur relatively straight edges. Median filtering is resistant to impulse noise (large changes in the intensity due to local noise), since outlier pixels will not skew the median value. Median filtering and other ‘order-statistic’ based filters are more appealing than simple linear filters, but have some undesirable properties. Median filtering is not effective at preserving the curved edges [Smith and Brady, 1997] often seen in biological imaging. Median filtering can also degrade fine image features, and can have undesirable effects in neighborhoods where more than two structures are represented. Due to the disadvantages of Median filtering, it is generally applied in low signal to noise ratio situations.

Anisotropic Diffusion Filtering (ADF) is a popular pre-processing step for MRI image segmentation, and has been included previously in tumor segmentation systems, including the works of [Vinitski et al., 1997, Kaus et al., 2001]. This technique was introduced in [Perona and Malik, 1990], and extended to MRI images in [Gerig et al., 1992]. As with mean and Gaussian filtering, ADF reduces noise through smoothing of the image intensities. Unlike mean and Gaussian filtering, however, ADF uses image gradients to reduce the smoothing effect from occurring across edges. ADF thus has the goal of smoothing within regions, but not between regions (edge-preserving smoothing). Furthermore, in addition to preserving edges, ADF enhances edges since pixels on each side of the edge will be assigned values representative of their structure. This is desirable in MRI image segmentation it reduces the effects of partial volume averaging.

One disadvantage of ADF is that, unlike Median filtering, it is sensitive to impulse noise, and thus can have undesirable effects if the noise level is high. The Anisotropic Median-Diffusion Filtering method was developed to address this weakness [Ling and Bovik, 2002], but this method introduces the degradation of fine details associated with Median filtering. Another disadvantage of ADF is that regions near thin lines and corners are not appropriately handled, due to their high image gradients [Smith and Brady, 1997].

A more recent alternative to ADF for edge-preserving and edge-enhancing smoothing is the Smallest Univalue Segment Assimilating Nucleus (SUSAN) filter [Smith and Brady, 1997]. This method weighs the contribution of neighboring pixels through a Gaussian in the spatial and the intensity domain. The use of a Gaussian in the intensity domain allows the algorithm to smooth near thin lines and corners. For example, rather than ignoring the region around a thin line (due to the presence of a high image gradient), the SUSAN filter weighs pixels on the line more heavily when evaluating other pixel on the line, and weighs pixels off the line according to pixels that are similar in (spatial location and) intensity to them. In addition to addressing this weakness of ADF, the SUSAN filter employs a heuristic to account for impulse noise. If the dissimilarity with neighboring pixels in the intensity and spatial domain is sufficiently high, a median filter is applied instead of the SUSAN filter.

In this example embodiment, the SUSAN filtering method was used because it has slightly better noise reduction properties than ADF and is less sensitive to the selection of the parameters. However, other filtering methods may be used in other embodiments.

### Inter-Slice Intensity Variation Reduction

The second step in the noise reduction phase is the reduction of inter-slice intensity variations. Due to gradient eddy currents and ‘crosstalk’ between slices in ‘multislice’ acquisition sequences, the two-dimensional slices acquired under some acquisition protocols may have a constant slice-by-slice intensity off-set [Leemput et al., 1999b]. It is noteworthy that these variations have different properties than the intensity inhomogeneity observed within slices, or typically observed across slices. As opposed to being slowly varying, these variations are characterized by sudden intensity changes in adjacent slices. A common result of inter-slice intensity variations is an interleaving between ‘bright’ slices and ‘dark’ slices [Simmons et al., 1994] (called the ‘even-odd’ effect). Gradually varying intensity changes between slices are corrected for in the intensity inhomogeneity reduction step, but most methods for intensity inhomogeneity reduction do not consider these sudden changes. The inter-slice intensity variation reduction step, therefore, attempts to reduce sudden intensity variations between adjacent slices.

In comparison to the estimation of slowly varying intensity inhomogeneities, correcting inter-slice intensity variations has received little attention in the medical imaging literature. One early attempt to correct this problem in order to improve segmentation was presented in [Choi et al., 1991]. This work presented a system for the segmentation of normal brains using Markov Random Fields, and presented two simple methods to reestimate tissue parameters between slices (after patient-specific training on a single slice). One method thresholded pixels with high probabilities of containing a single tissue type, while the other used a least squares estimate of the change in tissue parameters. A similar approach was used in one of the only systems thus far to incorporate this step for tumor segmentation [M. Ozkan, 1993]. This system first used patient-specific training of a neural network classifier on a single slice. When segmenting an adjacent slice, this neural network was first used to classify all pixels in the adjacent slice. The locations of pixels that received the same label in both slices were then determined, and these pixels in the adjacent slice were used as a new training set for the neural network classifier used to classify the adjacent slice. Each of these approaches require not only a tissue model, but patient-specific training.

An improved inter-slice intensity correction method was presented in [Leemput et al., 1999b]. This work presented two methods to incorporate inter-slice variation correction within an EM segmentation framework. The first simply incorporated slice-by-slice constant intensity offsets into the inhomogeneity estimation, while the second method computed a two-dimensional inhomogeneity field in each slice and used these to produce a three-dimensional inhomogeneity field that allowed inter-slice intensity variations. The method used by the INSECT system for this step was presented in [Zijdenbos et al., 1995] to improve the segmentation of MS lesions. This method estimated a linear intensity mapping based on pixels at the same location in adjacent slices that were of the same tissue type. Unfortunately, despite the lack of patient-specific training, these methods each still require a tissue model (in each slice) that may be violated in data containing significant pathology.

A method free of a tissue model was presented in [Vokurka et al., 1999]. This method used a median filter to reduce noise, and pruned pixels from the intensity estimation by upper and lower thresholding the histogram, and removing pixels repenting edges. The histogram was divided into bins and a parabola was fit to the heights of the 3 central bins, which determined the intensity mapping. Although model-free, this method makes major assumptions about the distribution of the histogram, which may not be true in all modalities or in images with pathological data. In addition, this method ignores spatial information.

Inter-slice intensity variation correction can be addressed using the same techniques employed in intensity standardization, which will be discussed below. However, most methods for intensity standardization employ a tissue model or a histogram matching method that will be sensitive to outliers. It was decided not to use one of the existing histogram matching methods in the example embodiment, since real data may have anisotropic pixels, where the tissue distributions can change significantly between slices. The methods in [Zijdenbos et al., 1995, M. Ozkan, 1993] were more appealing since these methods use spatial information to determine appropriate pixels for use in estimation. However, these methods rely on a tissue model. Although the method of [Vokurka et al., 1999] is a histogram matching method, removing points from the estimation in a model-free way is appealing. A simple method to identify good candidates for estimating the intensity between slices as in [Zijdenbos et al., 1995, M. Ozkan, 1993] will now be described but in a model-free way.

It is assumed that the intensity mapping between slices can be described by a multiplicative scalar value w, a model commonly used [Zijdenbos et al., 1995, Leemput et al., 1999b]. If it is assumed that the slices are exactly aligned such that each pixel in slice X corresponds to a pixel in slice Y of the same tissue type, then w could be estimated by solving the equation below (where X and Y are vectors of intensities and Xi has the same spatial location Yi within the image):

X*w=Y

However, since there will not be an exact mapping between tissue types at locations in adjacent slices, an exact value for w that solves this equation will not exist, and therefore the task becomes to estimate an appropriate value for w. One computationally efficient way to estimate a good value of w would be to calculate the value for w that minimizes the squared error between X*w and Y:

sumᵢ(Xi*w+Y)̂2

The optimal value for w in this case can be determined by using the ‘normal equations’ [Shawe-Taylor and Cristianini, 2004] (employing the matrix pseudoinverse):

w=(X^{T}X)⁻¹(X^{T}*Y)

Unfortunately, this computation is sensitive to areas where different tissue types are aligned, since these regions are given weight equal to that of pixels where tissue types are appropriately aligned in the adjacent slices. The value w thus simply minimizes the error between the intensities at corresponding locations in adjacent slices, irrespective of whether the intensities should be the same (possibly introducing additional inter-slice intensity variations). The objective must thus be modified to restrict the estimation of w to locations that actually should have the same intensity after the intensity transformation w is applied, but without an explicit segmentation or tissue model. An alternate approach to identifying tissues or performing a segmentation is to weight the errors based on the importance of having a small error between each corresponding location (Xi, Yi). Given a weighting of importance for each pixel, the calculation of w would focus on computing a value that minimizes the squared error for areas that are likely to be aligned, while reducing the effect of areas where tissues are likely misaligned. Given a ‘relevance’ weight for each i, termed R(i), the least squares solution can be modified to use this weight by performing element wise multiplication of both the vectors X and Y with R [Moler, 2002]. Scaling both vectors makes the errors after transformation with w proportional to the corresponding value in R. In Matlab™ notation, the value w can be computed as follows:

w=((X.*R)^{T}(X.*R))⁻¹(X.*R)^{T}(Y.*R)

If the image was segmented into anatomically meaningful regions, computing R(i) would be trivial, it would be 1 at locations where the same tissue type is present in both slices and 0 when the tissue types differ. Without a segmentation, this can be approximated. An intuitive approximation would be to weight pixels based on a measure of similarity between their regional intensity distributions. A method robust to intensity-scaling to perform this approximation is to compute the (regional) joint entropy of the intensity values. The (Shannon) joint entropy is defined as follows [Pluim et al., 2003]:

$$H ( {A}_{1} , {A}_{2} ) = - {\sum }_{i ∈ {A}_{1} j ∈ {A}_{2}} p ( i , j ) log p ( i , j )$$

The value p(i, j) represents the likelihood that intensity i in one slice will be at the same location as intensity j in the adjacent slice, based on an image region. In the example embodiment, a 9 pixel square window was used to compute the values of p(i, j) for a region, and divide the intensities into 10 equally spaced bins to make this computation. The frequencies of the 9 intensity combinations in the resulting 100 bins are used for the p(i, j) values (smoothing these estimates could give a less biased estimate). The joint entropy computed over these values of pij has several appealing properties. In addition to being insensitive to scaling of the intensities, it is lowest when the pixel region is homogeneous in both slices, will be higher if the intensities are not homogeneous in both slices but are spatially correlated, and will be highest when the intensities are not spatially correlated. After a sign reversal and normalization to the range [0,1], the joint entropy of the image regions could thus be used as values for R(i), which would encourage regions that are more homogeneous and correlated between the slices to receive more weight in the estimation of w than heterogeneous and uncorrelated regions.

Joint entropy provides a convenient measure for the degree of spatial correlation of intensities, which is not dependent on the values of the intensities as in many correlation measures. However, the values of the intensities in the same regions in adjacent slices should also be considered, since pixels of very different intensity values should receive decreased in weight in the estimation, even if they are both located in relatively homogeneous regions. Thus, in addition to assessing the spatial correlation of regional intensities, higher weight should be assigned to areas that have similar intensity values before transformation, and the weight should be dampened in areas where intensity values are different. The most obvious measure of the intensity similarity between two pixels is the absolute value of their intensity difference. This measure is computed for each set of corresponding pixels between the slices, and normalized to be in the range [0,1] (after a sign reversal). Values for R(i) that reflect both spatial correlation and intensity difference can be computed by multiplying these two measures. As a further refinement to this measure, the threshold selection algorithm from [Otsu, 1979] (and morphological filling of holes) is used to distinguish foreground (air) pixels from background (head) pixels, and R(i) is set to zero for pixels representing background areas in either slice (since they are not relevant to this calculation).

The weighted least squares estimation computes the linear mapping to the median slice in the sequence from each of the two adjacent slices. The implemented algorithm then proceeds to transform these slices, and then estimates the intensity mappings of their adjacent slices, continuing until all slices have been transformed. For T2 images, the intensities were inverted to provide a more robust estimation and to prevent degradation of the high intensity information, which is important for tumor segmentation.

Future implementations could expand on this method by computing a non-linear intensity mapping between the slices. Experiments with non-linear mappings showed that they were difficult to work with, since non-linear transformations tended to reduce image contrast. This process would thus need to be subjected to more advanced regularization measures.

### Intensity Inhomogeneity Reduction

The third step in the noise reduction phase is the reduction of intensity inhomogeneity across the volume. The task in this step is to estimate a three-dimensional inhomogeneity field, of the same size as the volume, which represents the intensity inhomogeneity. This field is often assumed to vary slowly spatially, and to have a multiplicative effect. The estimated field can be used to generate an image where the variance in intensity for each tissue type is reduced, and differences between tissue types are increased.

There exists an immense number of techniques for post-acquisition intensity inhomogeneity reduction. Discussed recently in [Gispert et al., 2004] are the causes of the intensity inhomogeneity, and many of the techniques proposed for automatic post-acquisition correction are surveyed in [Gispert et al., 2004, Shattuck et al., 2001], including methods based on linear and non-linear filtering, seed point selection, clustering, mixture models through expectation maximization with and without spatial priors, entropy minimization, hidden Markov models, and many other approaches. The diversity of methods proposed are the result of the difficulty in validating methods on real data sets and the lack of studies which quantitatively compares different methods.

Rather than introducing yet another technique, the utilization of an existing inhomogeneity correction algorithm is appealing, but it is not obvious which correction algorithm should be used. This is primarily due to the fact that new methods are often evaluated by comparing results before and after correction. Although it is clear that corrected volumes can improve segmentation, validating new methods without quantitative comparisons to existing methods makes selecting among the many existing correction algorithms difficult. In order to address this, [Arnold et al., 2001] performed a multi-center evaluation on real and simulated data of six correction algorithms, which were chosen as representative methods for different correction strategies. The methods examined were based on homomorphic filtering (HUM), Fourier domain filtering (EQ), thresholding and Gaussian filtering (CMA), a tissue mixture model approach using spatial priors (SPM99), the Nonparametric Nonuniform intensity Normalization algorithm (N3), and a method comparing local and global values of a tissue model (BFC). Although there was no clearly superior method, the BFC and the N3 methods generally provided a better estimation than the other methods. A more recent study compared the performance of four algorithms on the simulated data used in [Arnold et al., 2001], in addition to real data at different field strengths [Gispert et al., 2003]. The four methods examined were the N3 method, the SPM99 method, the SPM2 method (expectation maximization of a mixture model with spatial priors), and the author's NIC method (expectation maximization that minimizes tissue class overlap by modeling the histogram by a set of basis functions). The simulated data indicated that the NIC method was competitive with the N3 and BFC methods. The results on real data indicated that the N3 method outperformed the SPM99 and SPM2 methods, and that the NIC method outperformed the N3 method.

[Velthuizen et al., 1998] examined the effects of intensity inhomogeneity correction on brain tumor segmentation. The segmentation method used was a kNN classifier using the image intensities as features, employing patient-specific training. Although no performance gain was achieved, the methods evaluated were simple filtering methods, which have not performed well in the few comparative studies on correction methods. A study that compared different inhomogeneity correction algorithms in the presence of Multiple Sclerosis (MS) lesions was done in [Sled, 1997]. This work compared the N3 algorithm to an algorithm based on (automatic) seed point selection from segmented white matter regions (WM), and an expectation maximization fitting of a tissue mixture model with and without spatial priors (EM and REM, respectively). Although the REM method performed the best overall on simulated data, both of the EM based algorithms performed poorly on real data. Among these four methods, only the N3 algorithm does not rely on either a tissue model or a segmentation.

Judging by the quantitative evaluations performed on real data sets, the algorithms with the best performance on real data seem to be the NIC, BFC, and N3 algorithms. Since the NIC method is not automatic, and both the BFC and NIC methods assume a tissue model (which will be violated if large abnormalities are present), the most logical choice for a bias correction strategy would be the N3 method. Before examining this method in more detail, an observation based on the limited comparative studies in the literature is that on real data, with the exception of the BFC method, the N3 method has outperformed automatic methods that assume a tissue model. This might be an indication that assuming the brain is composed of only a small set of tissues (ie. 3) that are identifiable only by their intensity after bias correction may not be a valid assumption. These results also indicate that intensity inhomogeneity can be corrected as a pre-processing step, and does not necessarily need to be coupled with segmentation.

The Nonparametric Nonuniform intensity Normalization (N3) algorithm was designed for accurate intensity inhomogeneity correction in MRI images, without the need for a parametric tissue model [Sled, 1997] and [Sled et al., 1999]. One of the main goals of the authors of these works was to remove the dependency of the intensity correction on a priori anatomic information, such that inhomogeneity correction could be performed as a pre-processing step in quantitative analysis. As with most inhomogeneity correction methods, this work models the intensity inhomogeneity effect as a slowly varying multiplicative field. The main assumption underlying this method is that an image will consist of several components that occur with a high frequency. In typical brain images, these components might be nuclear gray matter, cortical gray matter, white matter, CSF, scalp, bone, or tissue types. Under this assumption, the histogram of a noise-free and inhomogeneity-free image should form a set of peaks at the intensities of these tissues (with a small number of partial volume pixels in between the peaks). If an image is corrupted by a slowly varying inhomogeneity field, however, these peaks in the histogram will be ‘flattened’, since the values that should be at the peak will vary slowly across the image. The N3 method seeks to estimate an underlying uncorrupted image where the frequency of the histogram is maximized (by ‘sharpening’ the probability density function of the observed image), subject to regularization enforcing that the field must be slowly varying (preventing degenerate solutions).

In the N3 method, the probability density function of the values in the inhomogeneity field are assumed to follow a zero-mean Gaussian distribution, which allows tractable computation of the underlying uncorrupted image. Under this assumption, the probability density for the (log) intensities of the underlying data can be estimated by deconvolution of the probability density for the (log) intensities of the observed image with a Gaussian distribution. The procedure iterates by repeated deconvolution of the current estimate of the true underlying data. After each iteration, an inhomogeneity field can be computed based on the current estimate of the underlying data. This field is affected by noise, and is smoothed by modeling it as a linear combination of (B-spline) basis functions. This smoothed field is used to update the estimated underlying probability density, which reduces the effects of noise on the estimation of the underlying probability. The algorithm converges empirically to a stable solution in a small number of iterations (the authors say that it is typically ten).

Consider the case of MRI brain images with pathology. Many approaches (such as the Expectation Maximization based approaches) rely on the segmentation of the image with a tissue model consisting of a fixed number of class (that are often assumed to have a Gaussian distribution). Inhomogeneity correction in the presence of pathology for these methods is challenging since the model's assumptions are violated in creating the segmentation that will be used to estimate the field. Erratic results have been reported for EM-based approaches in the presence of MS Lesions [Sled, 1997], which interfere with the histogram to a lesser extent than do large tumors. Furthermore, since the performance of EM algorithms depends heavily on having a good initialization, sensitivity even to normal anatomic variations can cause the algorithm to reach an unsatisfactory local optima [Sled, 1997]. Now consider the N3 approach, which does not rely on a segmentation or tissue model. Although this method does make assumptions about the intensity distribution, these assumptions apply to pathology in addition to normal data. This method has been shown to give effective inhomogeneity correction in the presence of MS lesions [Sled, 1997] and large tumors [Likar et al., 2001]. Intuitively, resistance to a small number of outliers interfering with the estimation is done through the same method that confers resistance to noise, the smoothing of the field estimations between iterations. A larger number of outliers will also not interfere in the estimation, since they will comprise an additional high frequency component of the histogram. However, one case where this method could fail is if the abnormal area varies in intensity across the image slowly enough that it mimics an inhomogeneity field effect. Although there is inherent ambiguity in determining tumor boundaries since edges may not be well defined, this does not indicate that the intensity varies slowly over large elements of the structure, and the transition from normal areas to abnormal areas is fast enough that it is has not been confused with inhomogeneity effects in experimentation.

A set of related approaches to the N3 method are methods based on entropy minimization. First proposed in [Viola, 1995], this idea has since been explored and extended in several works including [Mangin, 2000, Likar et al., 2001, Ashburner, 2002, Vovk et al., 2004]. Both the N3 method and the entropy minimization methods assume that the histogram should be composed of high frequency components that have been ‘flattened’ by the presence of an inhomogeneity field, and estimate a field that will result in a well clustered histogram. The main difference is that the N3 method assumes an approximately Gaussian distributed inhomogeneity field, while the entropy minimization methods directly estimate a field that will minimize the (Shannon) entropy. In [Likar et al., 2001], comparative experiments were made between the N3 algorithm, a method that estimates image gradients and normalizes homogeneous regions (FMI), and three entropy minimization methods. The entropy based approaches and the N3 approach all outperformed the FMI method, while the entropy based approaches and the N3 approach performed similarly for images of the brain, and one of the entropy based methods (M4) tended to outperform the other methods on average on images of other areas of the body. [Vovk et al., 2004] compared the M4 method to a new entropy minimization method that estimated entropy based on both intensity information and the results of image convolution with a Laplacian filter (a method that estimates the image second derivative). The new method outperformed the M4 method on simulated data and a limited set of real data, obtaining nearly optimal performance based on the author's measure.

Another recent approach that outperformed the N3 method in a small scale study was presented in [Studholme et al., 2004]. This method used an aligned template to estimate expected local image statistics in estimating the bias field. This type of method is obviously not appropriate for the task of brain tumor segmentation, since a large tumor will not be present in the template. Although several simple methods to account for outliers were previously described and more sophisticated template-based methods will be described below, these methods are for estimating global effects, rather than the local effects of intensity inhomogeneity. It is preferred to use a method that can use abnormal areas to enhance the bias field estimation, rather than extrapolating over abnormal areas or running the risk of the abnormal area being recognized as an inhomogeneity field effect.

Although the entropy minimization approaches have been introduced as a potential alternative to the N3 method, in this example embodiment the N3 method was used since it has been involved in a larger number of comparative studies and has been tested for a much larger variety of different acquisition protocols and scanners, and consistently ranks as one of the best algorithms. However, the entropy minimization approaches have shown significant potential in the limited number of comparative studies that they have been evaluated in, and these approaches typically require a smaller number of parameters than the N3 method, are slightly more intuitive, and have (arguably) more elegant formulations. Thus, a potential future improvement for this step could be the use of an entropy minimization approach (with the method of [Vovk et al., 2004] being one of the most promising).

### Summary of Noise Reduction

The noise reduction step consists of four steps or components. The first step is the reduction of local noise. This is done by using the SUSAN filter, which is a non-linear filter that removes noise by smoothing image regions based on both the spatial and intensity domains. This filter has the additional benefit that it enhances edge information and reduces the effects of partial volume averaging. The second step is the correction for inter-slice intensity variations. A simple least squares method is used to estimate a linear multiplicative factor based on corresponding locations in adjacent slices. This step uses a simple regularization measure to ensure that outliers do not interfere in the estimation, and to bias the estimation towards a unit multiplicative factor. The third step is the correction for smooth intensity variations across the volume. This step uses the N3 method, which finds a three-dimensional correcting multiplicative field that maximizes the frequency content of the histogram, but incorporates the constraint that the field varies slowly spatially. This technique is not affected by large pathologies, and does not rely on a tissue model that is sensitive to outliers. The fourth step is an additional step to remove regions that can be identified as noise after the two inhomogeneity correction steps. The SUSAN filter is again used for this step. A three-dimensional SUSAN filter should be used for this step, but a two-dimensional SUSAN filter was used during experimentation since the pixel sizes were anisotropic.

The implementation of the SUSAN filter present in the MIPAV package was used [MIPAV, Online]. Default values of 1 for the standard deviation, and 25 for the brightness threshold (the images were converted to an 8-bit representation) were used. The implementation of the N3 algorithm in the MIPAV package was also used. The work in [Sled et al., 1999] was followed in setting the parameters, using a Full Width at Half Maximum of 0.15, a field distance of 200 mm, a sub-sampling factor of 4, a termination condition of a change of 0.001, and setting the maximum number of iterations at 50. Adaptive histogram thresholding to distinguish foreground from background pixels was not used as suggested by the author, as it gave erratic results. The inter-slice intensity correction method was implemented using Matlab™ [MATLAB, Online], taking advantage of the pseudoinverse to compute the matrix inversion (with the smallest norm) in the least squares solution.

### Spatial Registration

Spatial registration comprises four steps: inter-modality coregistration, linear template registration, non-linear template registration, and interpolation. Medical image registration is a topic with an extensive associated literature. A survey of medical image registration techniques is provided in [Maintz and Viergever, 1998]. Although slightly dated due to the effects of several influential recent techniques, this extensive work categorizes over 200 different registration techniques based on 9 criteria. Although these criteria can be used to narrow the search for a registration solution, there remains decisions to be made among a variety of different methods, many of which are close variants with small performance distinctions.

The registration methods selected in this step are fully automatic and do not rely on segmentations, landmarks, or extrinsic markers present in the image. Furthermore, they each utilize three dimensional volumes, and use optimization methods that are computationally efficient.

### Coregistration

The first step in spatial registration is the spatial alignment of the different modalities. In this example embodiment, one of the modalities is defined as the target, and a transformation is computed for each other modality mapping to this target. This transformation is assumed to be rigid-body, meaning that only global translations and rotations are considered (since pixel sizes are known). Typically, coregistration is used as a method to align MRI images with CT images, or MRI images with PET images. Techniques that can perform these tasks are also well suited for the (generally) easier task of aligning MRI images with other MRI images of a different (or the same) modality. The major problem associated with the coregistration task has traditionally been to define a quantitative measure that assesses spatial alignment. Given this measure, the task is reduced to a search for a set of transformation parameters that optimize this measure. Since intensities are not meaningful when aligning images of different modalities, various measures have been proposed for coregistration that do not rely on minimizing the difference between images. Examples of these measures can be found in the influential work of [West et al., 1997], which evaluated 16 algorithms for the registration of MRI images with CT images, and MRI images with PET images. Currently, one of the most popular methods of coregistration in medical imaging is the maximization of the relative entropy measure known as Mutual Information (and its variants).

[Pluim et al., 2003] provide an excellent overview of the concepts of entropy and mutual information, a brief overview of their history, and provides an extensive survey of medical image registration techniques based on mutual information and its variants. Mutual Information requires the computation of the entropy of individual images. This measure utilizes the same formula as Joint Entropy, but the probabilities represent the likelihoods that each intensity will occur at a random pixel in the image. Two of the most common methods to calculate this probability include using the (normalized) intensity frequency described previously, and Parzen Windowing. The entropy of an image characterized in this way can be thought of as computing the predictability’ of the image intensities. Images that have a small number of high probability intensities will have low entropy as their intensities are relatively predictable. Conversely, images that have a more uniform distribution of probabilities will have high entropy, since several intensities are relatively equally predictable. Joint entropy for registration is often computed using a slightly different approach than the regional joint entropy discussed previously. In registration, the joint entropy is computed based on the entire region of overlap between the two volumes after transformation. Joint entropy is an appealing measure in this context for assessing the quality of an inter-modality (or intra-modality) alignment. This can be related to the idea of ‘predictability’. If two images are perfectly aligned, then the intensity of the first image could significantly increase the predictability of the intensity in the second image (and vice versa), since high probability intensity combinations will be present at the many locations of tissues with the same properties. However, if two images are misaligned, then the corresponding intensities in the second image will not be as predictable given the first image, since tissues in the first image will correspond to more random areas in the second image.

Minimizing joint entropy in general is not an appropriate measure to use unless images are already in fairly good alignment. This is due to the fact that a transformation which aligns background areas could achieve a low joint entropy [Pluim et al., 2003]. Mutual information addresses this shortcoming by including the entropies of each image in the region of overlap, and is commonly formulated as follows (with H(i) being the entropy of the region of overlap from image i, and H(i, j) being the joint entropy in the region of overlap from i and j):

MI(I₁,I₂)=H(I₁)+H(I₂)−H(I₁,I₂)

This measure will be high if the regions of overlap in the individual images have a high entropy (thus aligning background areas will result in a low score), but penalizes if the overlapping region has a high joint entropy (which is a sign of misalignment). This measure was originally applied to medical image registration by two different groups in [Collignon et al., 1995, Collignon, 1998, Viola, 1995, Wells et al., 1995]. It has gained popularity as an objective measure of an inter-modality alignment since it requires no prior knowledge about the actual modalities used, nor does it make assumptions about the relative intensities or properties of different tissue types in the modalities. The only assumption made is that the intensities of one image will most predictable, given the other image, when the images are aligned. Mutual information based registration is also appealing because it has well justified statistical properties, and it is relatively simple to compute.

One criticism of the Mutual Information metric is that in special cases in can decrease with increasing misalignment when images only partially overlap [Studholme et al., 1998]. In order to address this, the normalized mutual information was proposed in [Studholme et al., 1998]:

$$NMI ( {I}_{1} , {I}_{2} ) = \frac{H ( {I}_{1} ) + H ( {I}_{2} )}{H ( {I}_{1} , {I}_{2} )}$$

This measure offers improved results over mutual information based registration, and is the measure used in this example embodiment for coregistration. Coregistration is performed as a rigid-body transformation, and align each modality with a single target modality, which is of the same modality that will be used in template registration. Although mutual information based methods are very effective at the task of coregistration, their use of spatial information is limited to the intensities of corresponding pixels after spatial transformation. Although this allows accurate registration among a wide variety of both MRI and other types of modalities, there are some modalities, such as ultrasound, where maximizing mutual information based on spatially corresponding intensity values may not be appropriate [Pluim et al., 2003]. Future implementations could utilize methods such as those discussed in [Pluim et al., 2003] which incorporate additional spatial information to improve robustness and allow the coregistration of a larger class of image modalities.

### Linear Template Registration

Linear template registration is the task of aligning the modalities with a template image in a standard coordinate system. Coregistration of the different modalities has already been performed, simplifying this task, since the transformation needs to only be estimated from a single modality. The computed transformation from this modality can then be used to transform the images in all modalities into the standard coordinate system. In the example embodiment, linear template registration is included primarily as a preprocessing step for non-linear template registration. Computing the transformation needed for template registration is simpler than for coregistration, since the intensities between the template and the modality to be registered will have similar values. As with coregistration, there is a wealth of literature associated with this topic. A review of methods can be found in [Maintz and Viergever, 1998]. However, linear template registration is a relatively ‘easy’ problem compared to coregistration and non-linear template registration, since straightforward metrics can be used to assess the registration (as opposed to coregistration), and the number of parameters to be determined is relatively small (as opposed to non-linear registration).

In the example embodiment, the linear template registration method used is that outlined in [Friston et al., 1995] and [Ashburner et al., 1997]. This method uses the simple mean squared error between the transformed image and the template as a measure of registration accuracy. It computes a linear 12-parameter affine transformation minimizing this criteria. This consists of one parameter for each of the three dimensions with respect to translation, rotation, scaling, and shearing. An additional parameter is used to estimate a linear intensity mapping between the two images, making the method more robust to intensity non-standardization. The method operates on smoothed versions of the original images to increase the likelihood of finding the globally optimal parameters, and uses the Gauss-Newton optimization method from [Friston et al., 1995] to efficiently estimate the 13 parameters.

The main contribution of [Ashburner et al., 1997] was the introduction of a (Bayesian) method of regularization into the registration process. As discussed earlier, regularization during parameter estimation can be thought of as introducing a ‘penalty’ for parameters that are determined to be less likely by some criteria. An alternate, but equivalent, way to interpret regularization is that it considers not only the performance of the parameters (in this case the mean squared error resulting from using the parameters), but also simultaneously considers the likelihood of the parameters given prior knowledge of what the parameters should be. [Ashburner et al., 1997] use a maximum a posteriori (MAP) formulation, which is based on this interpretation of regularization. It assesses a registration based on both the mean squared error after transformation, and the prior probability of the transformations occurring based on the expected parameter values. The advantages of assessing the prior probabilities of the transformations are that the algorithm converges in a smaller number of iterations, and the parameter estimation is more robust in cases where the data is not ideal. An example of a case where the data is not ideal for registration is when there is significantly less data along one dimension than the other two (due to inter-slice gaps or anisotropic pixels). The disadvantage of including prior probabilities is that meaningful prior probabilities or expected values must be known. The parameters from the registration of 51 high-quality MRI images were used to estimate the prior probabilities in [Ashburner et al., 1997]. Interesting results of this included that shearing should be considered unlikely in two of the image planes, and that the template used was larger than a typical head since zooms of greater than 1 in each dimension were expected.

The method of [Friston et al., 1995, Ashburner et al., 1997] has several appealing properties, such as a method to account for intensity standardization, fast convergence to a regularized mean squared error solution, and robustness to anisotropic pixels, inter-slice gaps and other situations where the data is not ideal. Future implementations could use a cost function that is based on a measure of Mutual Information, rather than simply the mean squared error, this could confer additional robustness to intensity non-standardization.

### Non-Linear Template Registration (Warping)

Non-linear template warping to account for inter-patient anatomic differences after linear registration is becoming an increasingly researched subject. However, as with intensity inhomogeneity field estimation, it is difficult to assess the quality of a non-linear registration algorithm, since the optimal solution is not available (nor is optimality well-defined). In the example embodiment, it was considered preferred to have a method that has shown to perform well in comparative studies based on objective measures. However, an additional important constraint that was placed on the registration method used. Since non-linear warping can cause local deformations, it is essential that a non-linear warping algorithm is selected that has an effective method of regularization.

[Hellier et al., 2001] performed an evaluation of four non-linear registration methods, and a linear mutual information based registration method for registering images of the brain. It was found that the non-linear methods improved several global measures (such as the overlap of tissue types) compared to the linear method. However, the non-linear methods gave similar results to the linear method for the local measures used (distances to specific cortical structures). A more recent study by the same group [Hellier et al., 2002] evaluated the method of [Ashburner and Friston, 1999], which is included in the SPM99 software package [SPM, Online] and is extremely popular in the neuroscience community (see [Hellier et al., 2002] for statistics). This method performed similarly to the other non-linear methods for the global measures. However, it performed significantly better than the linear and each of the non-linear methods for the local measures.

As with the linear method of registration discussed above, the method outlined in [Ashburner and Friston, 1999] works on smoothed images and uses a MAP formulation that minimizes the mean squared error subject to regularization in the form of a prior probability. The parameters of this method consist of a large number of non-linear spatial basis functions that define warps (392 for each of the three dimensions), in addition to four parameters that model intensity scaling and inhomogeneity. The basis functions used are the lowest frequency components of the discrete cosine transform. The non-linear ‘deformation field’ is computed as a linear combination of these spatial basis functions. As opposed to linear template registration which has only a small number of parameters, the large number of parameters in this model means that regularization is necessary in order to ensure that spurious results do not occur. Without regularization over such an expressive set of parameters, the image to be registered could be warped to exactly match the template image (severely over-fitting). The prior probabilities are thus important to ensure that the warps introduced decrease the error enough to justify introducing the warp. Unlike in the linear method, this method does not compute the prior probabilities based on empirical measures for each parameter. Instead, the prior probability is computed based on the smoothness of the resulting deformation field (assessed using a measure known as ‘membrane energy’). This form of prior biases the transformation towards a globally smooth deformation field, rather than a set of sharp local changes that cause an exact fit. Note that this does not exclude local changes, but it discourages changes from uniformity that do not result in a sufficiently lower squared error.

On top of its elegant formulation and its computational efficiency, the method presented in [Ashburner and Friston, 1999] has the advantage that it is trivial to vary the degree of regularization. For the task of non-linearly registering images that could potentially have large tumors, a higher degree of regularization is needed than for registering images of normal brains. The algorithms appealing properties, wide use, and performance in comparative studies make the method of [Ashburner and Friston, 1999] an obvious choice for a non-linear registration algorithm. As with the linear template registration method, future implementations could examine methods that use mutual information based measures for this step, in order to improve robustness to intensity non-standardization. References regarding non-linear mutual information based registration can found in [Pluim et al., 2003]. An alternate (or parallel) direction to explore for future implementations would be to use multiple modalities to enhance the registration.

### Spatial Interpolation

After a transformation has been computed, an interpolation method is required to assign values to pixels of the transformed volume at the new pixel locations. This involves computing, for each new pixel location, an interpolating function based on the intensities of pixels at the old locations. Interpolation is an interesting research problem, which has a long history over which an immense amount of variations on similar themes have been presented. An extensive survey and history of data interpolation can be found in [Meijering, 2002]. This article also references a large number of comparative studies of different methods for medical image interpolation. The conclusion drawn based on these evaluations is that B-spline kernels are in general the most appropriate interpolator. Other studies that support this conclusion include [Lehmann et al., 1999], [Thevenaz et al., 2000] and [Meijering et al., 2001].

Interpolation with B-splines involves modeling the image as a linear combination of piecewise polynomial (B-spline or Haar) basis functions [Hastie et al., 2001]:

$${B}_{i , 1} ( x ) = 1 if {τ}_{i} \leq x < {τ}_{i + 1} , otherwise 0.$$

$${B}_{i , m} ( x ) = \frac{x - {τ}_{i}}{{τ}_{i + m - 1} - {τ}_{i}} {B}_{i , m - 1} ( x ) + \frac{{τ}_{i + m} - x}{{τ}_{i + m} - {τ}_{i + 1}} {B}_{i + 1 , m - 1} ( x )$$

In this formulation, B_{i,m} is the ith B-spline of order m, with knots T. Given an image represented as a linear combination of such basis functions, the intensity value of the image at any real-valued location can be determined. This approach is related to interpolation using radial basis functions such as thin-plate splines and Hardy's multiquadratics [Lee et al., 1997]. For higher-order B-splines, as with radial basis functions, modeling the image as a linear combination of slowly varying basis functions results in an interpolating surface that fits the known data points exactly, has continuous derivatives, and appropriately represents edges in the image. The coefficients of the B-spline basis functions that minimize the mean squared error can be determined in cubic time using the pseudoinverse as is typically done with radial basis function interpolation schemes. Unfortunately, cubic time is computationally intractable for the data set sizes being examined (even small three-dimensional volumes may have over one million data points). However, computing the B-spline coefficients can be done using an efficient algorithm based on recursive digital filtering [Unser et al., 1991]. This results in an interpolation strategy that is extremely efficient given its high accuracy.

A noteworthy point with respect to MRI interpolation with is that it has also been shown that B-splines converge to the ideal Sinc interpolating filter as their degree increases, see [Aldroubi et al., 1992] and [Unser et al., 1992]. Convolution by a Sinc function is the closest ‘real space’ approximation to Fourier interpolation [Ashburner and Friston, 2003b], and ‘windowed sinc’ approximations of the Sinc function are thus a popular interpolator for MRI data. However, windowed sinc interpolation is not necessarily the ideal method for interpolating (sampled) data, and B-splines have outperformed windowed sinc methods in comparative studies based on MRI and other data types [Lehmann et al., 1999], [Thevenaz et al., 2000] and [Meijering et al., 2001].

In the example embodiment, high-order B-spline for spatial interpolation was used for its high accuracy and low computational expense. Future implementations could examine radial basis function interpolation methods such as thin-plate and polyharmonic splines, and Hardy's multiquadratics. Recently, efficient methods have been proposed for determining the coefficients for these basis functions [Carr et al., 1997, Carr et al., 2001]. Another method that could be explored in the future is Kriging, which a Bayesian interpolation method [Leung et al., 2001].

### Summary of Spatial Registration

The spatial registration step comprises four steps or components: coregistration of the input images (for example, when using different image modalities), linear affine template registration, non-linear template warping, and spatial interpolation.

The co-registration step registers each modality with a template modality by finding a rigid-body transformation that maximizes the normalized mutual information measure. The T1-weighted image before contrast injection is used as the template modality. Different image modalities often result from images of the patient being taken at different times. However, some MRI methods can image more than one image modality at a time. In such cases, it may be necessary to co-register (align) them with the other image modalities if this wasn't done by the hardware or software provided by the MRI equipment manufacturer. Thus, in some cases co-registration may not be required because the input images have already been aligned with one another. It will be appreciated that the step of co-registration generally refers to aligning different images of the same patient which may have been taken at the same or different times, and may be of the same or different image modality.

The linear affine template registration computes a MAP transformation that minimizes the regularized mean squared error between one of the modalities and the template. The T1-weighted image before contrast injection is used to compute the parameters, and transformation of each of the coregistered modalities is performed using these parameters. As a template, the averaged single subject T1-weighted image from the ICBM View software was used [ICBM View, Online], which is related to the ‘colin27’ (or ‘ch2’) template from [Holmes et al., 1998].

Non-linear template warping refines the linear template registration by allowing warping of the image with the template to account for global differences in head shape and other anatomic variations. The warping step computes a MAP deformation field that minimizes the (heavily) regularized mean squared error. The regularization ensures a smooth deformation field rather than a large number of local deformations. The same template is used for this step, and as before the T1-weighted pre-contrast image is used for parameter estimation and the transformation is applied to all modalities.

The final step is the spatial interpolation of pixel intensity values at the new locations. High-order polynomial B-spline interpolation is used which models the image as a linear combination of B-spline basis functions. This technique has attractive Fourier space properties, and has proved to be the most accurate interpolation strategy given its low computational cost. To prevent interpolation errors from being introduced between registration steps, spatial interpolation is not performed after coregistration or linear template registration. The transformations from these steps are stored, and interpolation is done only after the final (non-linear) registration step.

Each of the four registration steps are implemented in the most recent Statistical Parametric Mapping software package (SPM2) from the Wellcome Department of Imaging Neuroscience [SPM, Online]. For coregistration, the normalized mutual information measure and default parameter values were used. For template registration, several modifications were made to the default behavior. The template image was smoothed with an 8 mm full width at half maximum kernel to decrease the likelihood of reaching a local minimum. The regularization (lambda) value was increased to 10 (heavy). The pixel resolution of the output volumes was changed to be (1 mm by 1 mm by 2 mm), and the bounding box around the origin was modified to output volumes conforming to the template's coordinate system. The interpolation method was changed from trilinear interpolation to B-spline interpolation, and used polynomial B-splines of degree 7. The transformation results were stored in mat files, which allowed transformations computed from one volume to be used to transform others, and allowed interpolation to be delayed until after non-linear registration.

### Intensity Standardization

Intensity standardization is the step that allows the intensity values to approximate an anatomical meaning. This subject has not received as significant of a focus in the literature as intensity inhomogeneity correction, but research effort in this direction has grown in the past several years. This is primarily due to the fact that it can remove the need for patient specific training or the reliance on tissue models, which may not be available for some tasks or for some areas of the body. Although EM-based methods that use spatial priors are an effective method of intensity standardization, they are not appropriate for this step.

The intensity standardization method used by the INSECT system was (briefly) outlined in [Zijdenbos et al., 1995] in the context of improving MS lesions segmentation, and was discussed earlier in this document in the context of inter-slice intensity variation reduction. This method estimates a linear coefficient between the image and template based on the distribution of ‘local correction’ factors. Another study focusing on intensity standardization for MS lesion segmentation was presented in [Wang et al., 1998], which compared four methods of intensity standardization. The first method simply normalized based on the ratio of the mean intensities between images. The second method scaled intensities linearly based on the average white matter intensity (with patient-specific training). The third method computed a global scale factor using a “machine parameter describing coil loading according to reciprocity theorem, computing a transformation based on the voltage needed to produce a particular ‘nutation angle’ (which was calibrated for the particular scanner that was used). The final method examined was a simple histogram matching technique based on a non-linear minimization of squared error applied to ‘binned’ histogram data, after the removal of air pixels outside the head. The histogram matching method outperformed the other methods, indicating that naive methods to compute a linear scale factor may not be effective at intensity standardization. In [Nyul and Udupa, 1999], another histogram matching method was presented (later made more robust in [Nyul et al., 2000]), which computed a piecewise intensity scaling based on ‘landmarks’ in the histogram. As with the others, this study also demonstrated that intensity standardization could aid in the segmentation of MS lesions. This method was later used in a study that evaluated the effects of inhomogeneity correction and intensity standardization [Madabhushi and Udupa, 2002], finding that these steps complemented each other, but that inhomogeneity correction should be done prior to intensity. Another method of intensity standardization was presented in [Christenson, 2003], that normalized white matter intensities using histogram derivatives. One method, that was used as a preprocessing step in a tumor segmentation system was presented in [Shen et al., 2003]. This method thresholded background pixels, and used the mean and variance of foreground pixels to standardize intensities. A similar method was used in [Collowet et al., 2004], comparing it to no standardization, scaling based on the intensity maximum, and scaling based on the intensity mean.

The methods discussed above are relatively simple and straightforward. Each method (with the exception of [Zijdenbos et al., 1995]) uses a histogram matching method that assumes either a simple distribution or at least a close correspondence between histograms. These assumptions can be valid for controlled situations, where the protocols and equipment used are relatively similar, and only minor differences exist between the image to be standardized and the template histogram. However, in practice this may not be the case, as histograms can take forms that are not well characterized by simple distributions, in addition to potential differences in the shapes of the input and template image histograms. This relates to the idea that a term like ‘T1-weighted’ does not have a correspondence with absolute intensity values, since there are a multitude of different ways of generating a T1-weighted image, and the resulting images can have different types of histograms. Furthermore, one ‘T1-weighted’ imaging method may be measuring a slightly different signal than another, meaning that tissues could appear with different intensity properties on the image, altering the histogram.

A more sophisticated recent method was presented in [Weisenfeld and Warfield, 2004]. This method used the Kullback-Leibler (KL) divergence as a measure of relative entropy between an image intensity distribution and the template intensity distribution. This method computed an inhomogeneity field that minimized this entropy measure, and thus simultaneously corrected for intensity inhomogeneity and performed intensity standardization. Relative entropy confers a degree of robustness to the histogram matching, but even this powerful method fundamentally relies on a histogram matching scheme and ignores potentially relevant spatial information. Without the use of spatial information to ‘ground’ the matching by using the image-specific characteristics of tissues, standardizing the histograms does not necessarily guarantee a standardization of the intensities of the different tissue types. The EM-based approaches (that use spatial priors) can perform a much more sophisticated intensity standardization, since the added spatial information in the form of priors allows individual tissue types to be well characterized. By using spatial information to locate and characterize the different tissue types, the standardization method is inherently standardizing the intensities based on actual tissue characteristics in the image modalities, rather than simply aligning elements of the histograms.

To date, most intensity standardization methods rely on a tissue model, or a relatively close match between the histograms of the input image and the template image. The presence of potentially large tumors makes it difficult to justify these assumptions. Previously, an explicit intensity standardization step has been used as a pre-processing phase to tumor segmentation in a manner that assumes a simple uni-modal intensity distribution (after subtraction of background pixels) [Shen et al., 2003], however bi-modal (or higher) distributions are evident in typical T1-weighted and T2-weighted images even when viewed at courser scales. Furthermore, known methods do not incorporate a means to reduce the effects of tumor and edema pixels (which are not present in the template image) on the estimation of the standardization parameters without the use of a tissue model. Thus, in the example embodiment, a simple method of intensity standardization was developed which is related to the approach for inter-slice intensity variation correction discussed earlier.

The method for inter-slice intensity variation correction used spatial information between adjacent slices to estimate a linear mapping between the intensities of adjacent slices, but used simple measures to weight the contribution of each corresponding pixel location to this estimation. For intensity standardization, the problems that complicate the direct application of this approach are determining the corresponding locations between the input image and the template image, and accounting for outliers (tumor, edema, and areas of mis-registration) that will interfere in the estimation. Determining the corresponding locations between the input image and the template was trivial for inter-slice correction, since it is assumed that adjacent slices would in general have similar tissues at identical image locations. Although typically not trivial for intensity standardization, non-linear template registration has been performed, thus the input image and template will already be aligned, and it can be assumed that locations in the input image and the template will have similar tissues.

In inter-slice intensity correction, the contribution of each pixel pair was weighted in the parameter estimation based on a measure of regional spatial correlation and the absolute intensity difference, which made the technique robust to areas where the same tissue type was not aligned. Since the input image will not be exactly aligned with the template image in the case of intensity standardization, these weights can also be used to make the intensity standardization more robust. However, intensity standardization is complicated by the presence of tumors and edema, which are areas that may be homogeneous and similar in intensity to the corresponding region in the template, but which do not want to influence the estimation. To account for this, a measure of regional symmetry was used as an additional factor in computing the weights used in the regression. The motivation behind this is that regions containing tumor and edema will typically be asymmetric [Gering, 2003a, Joshi et al., 2003]. Thus, giving less weight to asymmetric regions reduces the influence that abnormalities will have on the estimation.

A simple measure of symmetry is used, since the images have been non-linearly warped to the template where the line of symmetry is known. The first step in computing symmetry is computing the absolute intensity difference between each pixel and the corresponding pixel on the opposite side of the known line of symmetry. Since this estimation is noisy and only reflects pixel-level symmetry, the second step is to smooth this difference image with a 5 by 5 Gaussian kernel filter (the standard deviation is set to 1.25), resulting in a smoothly varying regional characterization of symmetry. Although symmetry is clearly insufficient to distinguish normal from abnormal tissues since normal areas may also be asymmetric, this weighting is included to decrease the weight of potentially bad areas from which to estimate the mapping, and thus it is not important if a small number of tumor pixels are symmetric or if a normal area is asymmetric.

The final factor that is considered in the weighting of pixels for the intensity standardization parameter estimation is the spatial prior ‘brain mask’ probability in the template's coordinate system (provided by the SPM2 software [SPM, Online]). This additional weight allows pixels that have a high probability of being part of the brain area to receive more weight than those that are unlikely to be part of the brain area. This additional weight ensures that the estimation focuses on areas within the brain, rather than standardizing the intensities of structures outside the brain area, which are not as relevant to the eventual segmentation task.

The weighted linear regression is performed between the image and the template in each modality. The different weights used are the negative regional joint entropy, the negative absolute difference in pixel intensities, the negative regional symmetry measured in each modality, and the brain mask prior probability. These are each scaled to be in the range [0,1], and the final weight is computed by multiplying each of the weights together (which assumes that their effects are independent). This method was implemented in Matlab™ [MATLAB, Online], and is applied to each slice rather than computing a global factor to ease computational costs.

There are several methods that could be explored to improve this step in future implementations. Different loss functions could be examined, since loss functions such as the absolute error and the Huber loss are more robust to outliers than the squared error measure used here [Hastie et al., 2001], though at a higher computational expense. In general, it has been found that non-linear transformations could reduce the average error between the images, but this came at the cost of reduced contrast in the images. This occurred even when using a simple additive factor in addition to the linear scale factor. Future work could further explore non-linear methods, and although methods based on tissue models have been purposely avoided up to this point in the example system, this may be a step that could benefit from a tissue model. One direction to explore with respect to this idea could be to use a method similar to the tissue estimation performed in [Prastawa et al., 2004], which used spatial prior probabilities for gray matter, white matter, and CSF to build a tissue model, but used an outlier detection scheme to make the estimation more robust. The weighting methods discussed, and symmetry in particular, could be incorporated into an approach similar to this strategy to potentially achieve more effective intensity standardization.

### Feature Extraction

At this point, the input images have been non-linearly registered with an atlas in a standard coordinate system, and have undergone significant processing to reduce intensity differences within and between images. However, the intensity differences have only been reduced, not eliminated. If the intensity differences were eliminated, then a multi-spectral thresholding might be a sufficiently accurate pixel-level classifier to segment the images, and feature extraction would not be necessary. Since the differences have only been reduced and ambiguity remains in the multi-spectral intensities, one cannot rely on a simple classifier which solely uses intensities. Below, many pixel-level features will be discussed that have been implemented to improve an intensity-based pixel classification. It should be noted that not all of the features presented were included in the example embodiment.

### Image-Based Features

Since considerable effort has been spent towards normalizing the intensities, the most obvious features to use are the standardized pixel intensities in each modality. Apart from including these features in some form, there can remain considerable uncertainty as to what are the best features. A simple set of additional features to use for a pixel-level classifier are the intensities of neighboring pixels, as was used in [Dickson and Thomas, 1997, Garcia and Moreno, 2004].

Including neighborhood intensities introduces a large amount of redundancy and added complexity to the feature set, which may not aid in discrimination. A more compact representation of the intensities within a pixel's neighborhood can be obtained through the use of multiple resolution features. Multiple resolutions of an image are often obtained by repeated smoothing of the image with a Gaussian filter and reductions of the image size. This is typically referred to as the Gaussian Pyramid [Forsyth and Ponce, 2003], and produces a set of successively smoothed images of decreasing size. Higher layers in the pyramid will represent larger neighborhood aggregations. The feature images would be each layer of the pyramid, resized to the original image size. This forms a more compact representation of neighborhood properties, since a small amount of features capture a similar amount of information (though some information is inevitably lost with this representation). Unlike the incorporation of neighboring intensities, the use of multi-resolution features has the advantage that it implicitly encourages neighboring pixels to be assigned the same label (with many classifiers), since the feature values of neighboring pixels at low resolutions will be very similar.

One drawback of using a Gaussian Pyramid approach is that a significant amount of information is lost at the lower resolutions. This is especially evident when viewing the upper layers of the pyramid at the same size as the original image. Depending on the interpolation algorithm used, the higher layers can have a blocky appearance (in the case of nearest neighbor interpolation), or can introduce spurious spatial information (in the case of linear or cubic methods). In considering that these features will be used to classify individual pixels, it is clear that discarding the small differences between neighboring pixels when decreasing the image size will not help in discrimination. The primary motivation for performing re-sampling has traditionally (and even recently) been cited as computational cost [Forsyth and Ponce, 2003]. Although this is essential in some applications where Gaussian pyramids are used (such as hierarchical Markov Random Fields), in the present application there is no benefit in computational expense to a smaller image size at coarse resolutions, and a convolution is considered to be a computationally reasonable operation. Thus, the use of a Gaussian Cube was explored where each layer in the cube is computed by convolution of the original image with a Gaussian kernel of increasing size and variance. This approach is similar to that used to compute several of the texture features in [Leung and Malik, 2001].

An additional advantage of using a Gaussian Cube representation for multi-resolution features is that linear combinations of these features will form differences of Gaussians, which are a traditional method of edge detection similar to the Laplacian of Gaussian operator [Forsyth and Ponce, 2003]. Thus the Gaussian cube explicitly encodes low-pass information but also implicitly encodes high-pass information. Also explored was using different sizes of the Laplacian of Gaussian filter to form a Laplacian Cube.

Three methods were explored for incorporating intensity distribution based information into the features. The first method computed a pixels intensity percentile within the image histogram, resulting in a measure of the relative intensity of the pixel with respect to the rest of the image. Although this can theoretically overcome residual problems with intensity non-standardization, it is sensitive to the anatomic structures present within the image. The second method of incorporating histogram information that was explored was to calculate a simple measure of the histogram density at the pixel's location. This was inspired by the ‘density screening’ operation used in [Clark et al., 1998], and is a measure of how common the intensity is within the image. The density was estimated by dividing the multi-spectral intensity values into equally sized bins (cubes in the multi-spectral case). This feature was computed as the (log of) the number of intensities within the pixel's intensity's bin. The third type of feature explored to take advantage of intensity distribution properties was computing a ‘distance to normal intensity tissue’ measure. These features computed the multi-spectral Euclidean distance from the pixel's multi-spectral intensities to the (mean) multi-spectral intensities of different normal tissues in the template's distributions (which the images have been standardized to).

A set of important image-based features are texture features. There exists a large variety of methods to compute features that characterize image textures. Reviews of different methods can be found in [Materka and Strzelecki, 1998, Tuceryan and Jain, 1998], and more recent surveys can be found in [Forsyth and Ponce, 2003, Hayman et al., 2004]. In the medical image processing literature, the most commonly used features to characterize textures are the ‘Haralick’ features, which are a set of statistics computed from a gray-level spatial coocurrence matrix [Haralick et al., 1973]. The coocurrence matrix is an estimate of the likelihood that two pixels of intensities i and j (respectively) will occur at a distance d and an angle of within a neighborhood. The matrix is often constrained to be symmetric, and the original work proposed 14 statistics to compute this matrix which included measures such as angular second momentum, contrast, correlation, and entropy. The statistical values computed from the coocurrence matrix represent the texture parameters, and are typically calculated for a pixel by considering a square window around the pixel. Variations on these types of texture features, which are often combined with ‘first order features, have been shown to provide increased discrimination between tumor pixels and normal pixels from normal tissue types [Schad et al., 1993, Kjaer et al., 1995, Herlidou-Meme et al., 2003, Mahmoud-Ghoenim et al., 2003]. A major factor to be considered in computing these features is the method through which the coocurrence matrix is constructed.

In our experiments, the coocurrence matrix was constructed by considering only pixels at a distance of exactly 1 from each other, and computing the estimate between intensity i and j at this distance independent of the angle. The intensities were divided into equally sized bins to reduce the sparsity of the coocurrence matrix. More sophisticated methods that could have been used include evaluating different distances or angles, smoothing the estimates, or weighting the contribution of pixel pairs to the coocurrence (which could use a radially decreasing weighting of the neighbors). The statistical features of the coocurrence matrix that were measured follow [Muzzolini et al., 1998], and are angular second momentum (ASM), contrast (CON), entropy (ENT), cluster shade (CS), cluster prominence (CP), inertia (IN), and local homogeneity (LH). Correlation was removed from the set in [Muzzolini et al., 1998] rather than working around division by zero valued standard deviations (for entropy, it was assumed that zero multiplied by the log of zero is zero). The final set of texture parameters were as follows:

$$ASM = {\sum }_{i = 0}^{G - 1} {\sum }_{j = 0}^{G - 1} {P ( i , j )}^{2}$$

$$CON = {\sum }_{i = 0}^{G - 1} {n}^{2} {\sum }_{\vert i - j \vert = n} P ( i , j )$$

$$A BS = {\sum }_{i = 0}^{G - 1} {\sum }_{j = 0}^{G - 1} \vert i - j \vert P ( i , j )$$

$$ENT = {\sum }_{i = 0}^{G - 1} {\sum }_{j = 0}^{G - 1} - P ( i , j ) ln P ( i , j )$$

$$CS = {\sum }_{i = 0}^{G - 1} {\sum }_{j = 0}^{G - 1} {( i + j - {μ}_{x} - {μ}_{y} )}^{3} P ( i , j )$$

$$CP = {\sum }_{i = 0}^{G - 1} {\sum }_{j = 0}^{G - 1} {( i + j - {μ}_{x} - {μ}_{y} )}^{4} P ( i , j )$$

$$IN = {\sum }_{i = 0}^{G - 1} {\sum }_{j = 0}^{G - 1} {( i - j )}^{2} P ( i , j )$$

$$LH = {\sum }_{i = 0}^{G - 1} {\sum }_{j = 0}^{G - 1} \frac{1}{1 + {( i - j )}^{2}} P ( i , j )$$

Also explored were first-order texture parameters (statistical moments). These parameters ignore spatial information and are essentially features that characterize properties of the local histogram. The parameters from [Materka and Strzelecki, 1998] were calculated, which are mean, variance, skewness, kurtosis, energy, and entropy. Note that the variance value was converted to a standard deviation value. The first-order texture parameters used are defined as follows:

$$Mean \text{:} μ = {\sum }_{i = 0}^{G - 1} iP ( i )$$

$$Variance \text{:} {σ}^{2} = {\sum }_{i = 0}^{G - 1} {( i - μ )}^{2} P ( i )$$

$$Skewness \text{:} {μ}_{3} = {σ}^{- 3} {\sum }_{i = 0}^{G - 1} {( i - μ )}^{3} P ( i )$$

$$Kurtosis \text{:} {μ}_{4} = {σ}^{- 4} {\sum }_{i = 0}^{G - 1} {( i - μ )}^{4} P ( i )$$

$$Energy \text{:} E = {\sum }_{i = 0}^{G - 1} {P ( i )}^{2}$$

$$Entropy \text{:} H = - {\sum }_{i = 0}^{G - 1} P ( i ) log P ( i )$$

Within the Computer Vision literature, a currently popular technique for computing texture features is through linear filtering [Forsyth and Ponce, 2003], which represents a different approach than the Haralick features. The intuition behind using the responses of linear filters for texture parameters is that (balanced) filters respond most strongly to regions that appear similar to the filter [Forsyth and Ponce, 2003]. Thus, convolving an image with a variety of linear filters can assess how well each image region matches a set of filter ‘templates’, and the results can be used as a characterization of texture. There exists considerable variation between methods based on this general concept, and it includes methods based on Gabor filters, eigenfilters, Discrete Cosine Transforms, and finally Wavelet and other optimized methods. [Randen and Husoy, 1999] performed a comparative study of a large variety of texture features based on linear filtering, but added Haralick features and another type of ‘classical’ method of representing features (autoregressive models). Although the study concluded that several of the linear filtering methods generally performed better than most others and that the classical methods generally performed poorly (as did several of the linear filtering approaches), it was also stated that the best methods depended heavily on the data set used and that the classical methods may be more appropriate in specific instances. Based on this conclusion (and several similar ones from related studies discussed in [Randen and Husoy, 1999], the evaluation of a classical approach may still be worthwhile, though it should preferably evaluate an approach based on linear filtering. An influential recent approach was proposed in [Leung and Malik, 2001], which used a set of filters consisting of Gaussians, Laplacian of Gaussians, and oriented Gaussian derivatives to form a filter bank, whose outputs used as features offered a relative invariance to changes in illumination and viewpoint. A recent comparative study [Varma and Zesserman, 2002] evaluated four state of the art filter banks for the task of texture classification including the approach of [Leung and Malik, 2001]. This study found that the rotation invariant version of the Maximum Response filter bank (MR8) generally proved to be the best set of texture features for classification. This Maximum Response filter bank is derived from the Root Filter Set filter bank, which consists of a single Gaussian filter, a single Laplacian filter, and 36 Gabor filters (6 orientations each measured at 3 resolutions for both the symmetric and the asymmetric filter). A Gabor filter is a Gaussian filter that is multiplied element-wise by a one-dimensional cosine or sine wave to give the symmetric and asymmetric filters, respectively (this filter has analogies to early vision processing in mammals [Forsyth and Ponce, 2003]).

$${G}_{symmetric} ( x , y ) = cos ( {k}_{x} x + {k}_{y} y ) {e}^{\frac{{z}^{2} + {y}^{2}}{2 {σ}^{2}}}$$

$${G}_{asymmetric} ( x , y ) = sin ( {k}_{x} x + {k}_{y} y ) {e}^{- \frac{{x}^{2} + {y}^{2}}{2 {σ}^{2}}}$$

The Maximum Response (MR) filter banks selectively choose which of the Gabor filters in the Root Filter Set should be used for each pixel based on the filter responses (the Gaussian and Laplacian are always included). The MR8 filter bank selects the asymmetric and symmetric filter at each resolution that generated the highest response. This makes the filter bank which is already (relatively) invariant to illumination also (relatively) invariant to rotation. Another appealing aspect of the MR8 filter bank is that it consists of only 8 features, giving a compact representation of regional texture. Since Gaussians and Laplacians were already being explored in this work, only the 6 additional (Gabor) features were required to take advantage of this method for texture characterization. The MR8 texture features were implemented (using the Root Filter Set code from the author's webpage) as an alternate (or possibly complementary) method of taking into account texture in the features.

The fourth type of Image-based features discussed in above was structure based features. These features are based on performing an initial unsupervised segmentation to divide the image into homogeneous connected regions, and computing features based on the regions to which the pixel was assigned. These types of features are commonly referred to as shape or morphology based features, and includes measures such as compactness, area, perimeter, circularity, moments, and many others. A description of many features of this type can be found in [Dickson and Thomas, 1997, Soltanian-Zadeh et al., 2004]. Beyond morphology based features, features can also be computed that describe the relationship of the pixel to or within its assigned region, such as the measure used in [Gering, 2003b] to assess whether pixels were in a structure that was too thick. Another set of features that could be computed after performing an initial unsupervised segmentation would be to calculate texture features of the resulting region. The Haralick features or statistical moments would be more appropriate than linear filters in this case, due to the presence of irregularly shaped regions. When evaluating structure based features, an unsupervised segmentation method should be used that can produce a hierarchy of segmented structures. Since the abnormal classes will not likely fall into a single cluster, evaluating structure based features at multiple degrees of granularity could give these features increased discriminatory ability. Structure-based features were not tested in the example embodiment, but represent an interesting direction of future exploration.

The features discussed (multi-model pixel intensities, neighboring pixel intensities, Gaussian pyramids and cubes, Laplacian cubes, intensity percentiles, multi-spectral densities, multi-spectral distances to normal intensities, first order texture parameters, coocurrence based texture features, and the MR8 filter bank) were implemented in Matlab™. In addition to structure-based features, futures directions to examine include performing multi-modality linear filtering or computing multi-modality textures. Given that the multi-spectral distances to normal intensities proved to be useful features, another direction of future research could be to incorporate the variance and covariance of the normal tissue intensities in the template intensity distribution into the ‘distance from normal intensity’ measure (possibly through the use of the Mahalanobis distance as suggested in [Gering, 2003b]). A final direction of future research with respect to image-based features is the evaluation of texture features based on generative models (such as those that use Markov Random Fields), which are currently regaining popularity for texture classification and have shown to outperform the MR8 filter bank by one group [Varma and Zisserman, 2003].

### Coordinate-Based Features

The simplest form of coordinate-based feature is obviously spatial coordinates. However, these features were not examined, as they are only applicable if the tumor is highly localized, or a large training set is available. Even though many of our experiments may have benefited from the use of coordinates, it was decided not to evaluate these features since in general they will not be used.

The coordinate-based features that have been used in other systems are the spatial prior probabilities for gray matter, white matter, and CSF. The probabilities most commonly used are those included with the SPM package [SPM, Online]. The most recent version of this software includes templates that are derived from the ‘ICBM152’ data set [Mazziotta et al., 2001] from the Montreal Neurological Institute, a data set of 152 normal brain images that have been linearly aligned and where gray matter, white matter, and csf regions have been defined. The SPM versions of these priors mask out non-brain areas, reduce the resolution from 1 mm3 isotropic pixels to 2 mm3 isotropic pixels, and smooth the results with a Gaussian filter. Rather than use the SPM versions, the ‘tissue probability models’ from the ICBMI52 data set obtained from the ICMB View software [ICBM View, Online] were used. These were chosen since the system has a separate prior probability for the brain (removing the need for masking), since these have a higher resolution (1 mm by 1 mm by 2 mm pixels), and since these probabilities can be measured multiple resolutions which allows the use of both the original highly detailed versions and smoothed versions. For a brain mask prior probability, the prior included with SPM2 was used, which is derived from the MN1305 average brain [Evans and Collins, 1993], and is re-sampled to 2 mm3 isotropic pixels and smoothed as with the other SPM prior probabilities.

For a simple measure of anatomic variability, the average images constructed from the ICBM152 data set (also obtained from the ICBM View tool) were used. These consist of average T1-weighted and T2-weighted images from the 152 linearly aligned patient. This represents a measure of the average intensity expected at each pixel in the coordinate system, and is an important feature since a large divergence from average may indicate abnormality. This average measure is only a crude measure of variability, and future implementations could examine more sophisticated probabilistic brain atlases, such as those discussed in [Toga et al., 2003].

In addition to more sophisticated measures of anatomic variability, future implementations could examine the effectiveness of additional prior probabilities. This could include spatial prior probabilities for tissues such as bone, connective tissues, glial matter, fat, nuclear gray matter, muscle, or skin.

### Registration-Based Features

If the registration stage performed perfect registration, a regional similarity metric between the image and template could be used to find areas of abnormality. However, as with intensity standardization, the registration stage is not expected to be perfect and thus a regional similarity measure will not be a sufficient feature for abnormality segmentation. However, registration-based features have only begun to be explored to enhance segmentation, and they represent potentially very useful features to include alongside other features to enhance segmentation.

The only system to date that has used a registration-based feature for brain tumor segmentation was that in [Kaus et al., 2001] (the use of spatial prior probabilities is considered to be a coordinate-based feature). This system used a distance transform that computed the distance to labelled regions in the template. Distance transforms were not examined since spatial prior probabilities measured at different resolutions can represent similar information in a more elegant way. Under the same logic, examine other features that are based on labeled regions in a template were not examined.

Rather than using features based on template labels, features that used the template image data directly were explored, which encodes significantly more information (and does not require manual labelling of structures). The simplest way to incorporate template image data as a feature is to include the intensity of the pixel at the corresponding location in the template. This feature has an intuitive use, since normal regions should have similar intensities to the template while a dissimilarity could be an indication of abnormality. Although this direct measurement of intensities (at multiple resolutions) was only explored, texture features could have been used as an alternative or in addition to intensities. Measuring local difference, correlation, or other information measures such as entropy were considered to utilize the template image data, but were not explored in this work.

To measure symmetry as a feature, the difference between a pixel's intensity and the corresponding pixel's intensity on the opposite side of the image's mid-saggital plane (which was defined utilizing the template's mid-saggital plane) was computed. As with other features, multi-resolution versions of this feature by smoothing was explored. This represents an important feature since, as discussed in [Gering, 2003a], symmetry can be used as a patient-specific template of a normal brain, and thus asymmetric regions are more likely to be abnormal. As with utilizing the template's image information, texture features or other more sophisticated measures could have been computed.

Morphology or other features that take advantage of how the image was warped during registration were not explored, and this is an interesting future direction to explore in future implementations. Another interesting future direction therefore could be the incorporation of registration-based features from multiple templates, since the registration-based features explored used only a single template.

### Feature-Based Features

Our exploration of feature-based features was limited. Multi-resolution versions of image-, coordinate-, and registration-based features were examined. However, the inclusion of neighborhood feature values or computing texture values based on features other than the intensities were not examined. Automatic feature selection or dimensionality reduction were not a examined, which are future directions of research that could improve results, nor were sequences of feature extraction operations examined, which could improve results but whose meanings are not necessarily intuitive and would require automated feature extraction. This would include, for example, computing the Haralick features of a low resolution version of the filter bank results (or simply recursively computing the filter outputs).

### Summary of Feature Extraction

It is important to note that it is often the combination of different types of features which allows a more effective classification. For example, knowing that a pixel is asymmetric on its own is relatively useless. Even with the additional knowledge that the pixel has a high T2 signal and a low T1 signal would not allow differentiation between CSF and edema. However, consider the use of the additional information that the pixel's region has a high T2 signal and low T1 signal, that the pixel's intensities are distant in the standardized multi-spectral intensity space from CSF, that the pixel has a low probability of being CSF, that a high T2 signal is unlikely to be observed at the pixel's location, that the pixel has a significantly different intensity than the corresponding location in the template, and that the texture of the image region is not characteristic of CSF. It is clear from this additional information that the pixel is likely edema rather than CSF. It is also clear that the use of this additional information will add robustness to classification, since each of the features can be simultaneously considered and combined in classifying a pixel as normal or tumor. From the above, it will be appreciated that simply using the intensities as features or converting a neighborhood of intensities into a feature vector does not fully take advantage of even the image data, much less the additional information that can be gained through registration.

Not all of the features implemented were included in the final system. Based on our experiments, the final system included the multi-spectral intensities, the spatial tissue prior probabilities, the multi-spectral spatial intensity priors, the multi-spectral template intensities, the distances to normal tissue intensities, and symmetry all measured at multiple resolutions. In addition, the final system measured several Laplacian of Gaussian filter outputs and the Gabor responses from the MR8 filter bank for the multi-spectral intensities (although ideally these would be measured for all features and an automated feature selection algorithm would be used to determine the most relevant features).

Although examples of various different types of features were explored in this work, it should be emphasized that there remains a considerable amount of exploration that can be made with respect to feature extraction. More sophisticated coordinate-based and registration-based features in particular represent areas with significant future potential, as known methods do not explore the use of more than one type of feature from these classes. Automated feature selection or dimensionality reduction also represent areas of exploration that could improve results, as these operations were not explored in this work. The computation of each of the features discussed in this section was implemented in Matlab™ [MATLAB, Online].

### Classification

Supervised classification of data from a set of measured features is a classical problem in machine learning and pattern recognition. In the implemented system in the example embodiment, the task in classification is to use the features measured at a pixel to decide whether the pixel represents a tumor pixel or a normal pixel. Manually labeled pixels will be used to learn a model relating the features to the labels, and this model will then be used to classify pixels for which the label is not given (from the same or a different patient). As discussed above, there have been a variety of different classification methods proposed to perform the task of brain tumor segmentation using image-based features (although most of the previous work has assumed patient-specific training). Multilayer Neural Networks have been used by several groups [Dickson and Thomas, 1997, Alirezaie et al., 1997, M. Ozkan, 1993], and are appealing since they allow the modeling of non-linear dependencies between the features. However, training multilayer networks is problematic due to the large amount of parameters to be tuned and the abundance of local optimums. Classification with Support Vector Machines (SVM) has recently been explored by two groups for the task of brain tumor segmentation [Zhang et al., 2004, Garcia and Moreno, 2004], and Support Vector Machines are an even more appealing approach for the task of binary classification since they have more robust (theoretical and empirical) generalization properties, achieve a globally optimal solution, and also allow the modeling of non-linear dependencies in the features [Shawe-Taylor and Cristianini, 2004].

In the task of binary classification, if the classes are linearly separable in the feature space (and assuming approximately equal covariances and numbers of training instances from both classes), then the logic behind Support Vector Machine classification is that the best linear discriminant for classifying new data will the be the one that is furthest from both classes. Binary classification with (2-class hard) Support Vector Machines is based on this idea of finding the linear discriminant (or hyperplane) which maximizes the margin (or distance) to both classes in the feature space. The use of this margin maximizing linear discriminant in the feature space provides guaranteed statistical bounds on how well the learned model will perform on pixels outside the training set [Shawe-Taylor and Cristianini, 2004]. The task of finding the margin maximizing hyperplane can be formulated (in its dual form) as the maximization of the following expression [Russell and Norvig, 2002]:

$${\sum }_{i} {α}_{i} - \frac{1}{2} {\sum }_{i , j} {α}_{i} {α}_{j} {y}_{i} {y}_{j} ( {x}_{i} \cdot {x}_{y} )$$

Subject to the constraints that ALPHA NOT ZERO and ALPHAiyi ZERO, where xᵢ is a vector of the features extracted for the ith training pixel, yᵢ is 1 if the ith training pixel is tumor and −1 otherwise, and i are the parameters to be determined. This formulation under the above constraints can be formulated as a Quadratic Programming optimization problem whose solution is guaranteed to be optimal and can be found efficiently. A new pixel for which the labels are not known can be classified using the following expression [Russell and Norvig, 2002]:

$$h ( x ) = sign ( {\sum }_{i} {a}_{i} {y}_{i} ( x \cdot {x}_{i} ) )$$

In the optimal solution, most of the i values will be zero, except those close to the hyperplane. The training vectors with non-zero values are referred to as Support Vectors. If the classification rule above is examined, it can be seen that only these Support Vectors are relevant in making the classification decision, and that other training points can be discarded since their values can be easily predicted given the Support Vectors (and associated weight values). This sparse representation allows efficient classification of new pixels, and leads to efficient methods of training for large training and features sets.

The Support Vector Classification formulation above learns only a linear classifier, while previous work on brain tumor segmentation indicates that a linear classifier may not be sufficient. However, the fact that the training data is represented solely as an inner (or ‘dot’) product allows the use of the kernel trick. The kernel trick can be applied to a diverse variety of algorithms (see [Shawe-Taylor and Cristianini, 2004]), and consists of replacing the inner product with a different measure of similarity between feature vectors. The idea behind this transformation is that the data can be implicitly evaluated in a different feature space, where the classes may be linearly separable. This is similar to including combinations of features as additional features, but removes the need to actually compute or store these combinations (of which there can be an exponential or infinite number represented through the kernel). The kernel function used needs to have very specific properties and thus arbitrary similarity metrics can not be used, but research into kernel functions has revealed many different types of admissible kernels, which can be combined to form new kernels [Shawe-Taylor and Cristianini, 2004]. Although the classifier still learns a linear discriminant, the linear discriminant is in a different feature space, and will form a non-linear discriminant in the original feature space.

The two most popular non-linear kernels are the Polynomial and the Gaussian kernel (sometimes referred to as the Radial Basis Function kernel, which is a term that will be avoided). The Polynomial kernel simply raises the inner product to the power of a scalar value d (other formulations add a scalar value R to the inner product before raising to the power of d). The feature space that the data points are evaluated in then corresponds to a feature space that includes all monomials (multiplications between features) up to degree d. Since there are an exponential amount of these monomials, it would not be feasible to use these additional features for higher values of d, or even for large feature sets. The Gaussian kernel replaces the inner product with a Gaussian distance measure between the feature vectors. This kernel space is thus defined by distances to the training pixels in the feature space (which should not be confused with the distance within an image). This kernel can be effective for learning decision boundaries which deviate significantly from a linear form. More complicated feature spaces can allow more effective discrimination of the training data, but at the cost of increased model complexity. More Support Vectors are needed to define a hyperplane in complicated feature spaces, and increasingly complicated feature spaces will eventually overfit the training data without providing better generalization on unseen test data. For example, when using the Polynomial kernel, higher values of d will lead to feature spaces where the classes are increasingly separable in the training data, but the linear separators found will be more heavily biased by the exact values of the training pixel features and will not necessarily accurately classify new pixels. In selecting a kernel, it is thus important to select a kernel which allows separation in the feature space, but to note that increased separability of the training data in the feature space does not guarantee higher classification accuracy of the learned model on test data.

It is possible that a linear discriminant in a given kernel feature space embedding will accurately classify most of the pixels in the training data, but noise and outliers may mean that the classes are not linearly separable in the feature space. There exist natural methods of regularization for Support Vector Machines which can overcome cases of non-separability, one of the most popular of which is the use of slack variables, which are variables added to the Quadratic Programming formulation which allow a specified amount of margin violation [Shawe-Taylor and Cristianini, 2004]. An equivalent but slightly more intuitive method of regularization is the −SVM formulation, which regularizes the number of Support Vectors in the learned model [Shawe-Taylor and Cristianini, 2004].

Although it has been stated that the Quadratic Programming formulation can be solved efficiently (for its size), the formulation can still involve solving an extremely large problem, especially in the case of image data where a single labeled image can contribute tens of thousands of training points. Fortunately, optimization methods such as Sequential Minimal Optimization [Platt, 1999], the SVM-Light method [Joachims, 1999], and many others exist that can efficiently solve these large problems.

In this implementation, the Linear and Polynomial kernels, slack variables for regularization, and the SVM-Light optimization method were used. A degree of 2 was used in the Polynomial kernel, which performed slightly better on average than higher degree kernels. The Gaussian kernel outperformed these kernels in some experiments, but it proved to be sensitive to the selection of the kernel parameters and performed much worse than the linear and polynomial kernels in some cases. In our experiments, each of the features was scaled to be in the range [−1,1], to decrease the computational cost of the optimization and to increase separability in the case of Polynomial kernels. Sub-sampling of the training data was also implemented to reduce computational costs. The sub-sampling method used allowed different sub-sampling rates depending on properties of the pixel. The three different cases used for this purpose were: tumor pixels, normal pixels that had non-zero probability of being part of the brain, and normal pixels that had zero probability of being part of the brain. It was found that the latter case could be sub-sampled heavily or even eliminated with minimal degradation in classifier accuracy.

There remain several directions of future exploration with respect to the classification step. Firstly, only 2 non-linear kernels were examined, and both were general purpose kernels. Specific kernels for image and graph data exist, and some kernels such as the Hausdorff kernel have been applied to related tasks [Barla et al., 2002]. With respect to the classifier used, our experiments indicated that ensemble methods were a promising approach, and could be examined further. Future implementations could also examine techniques such as the Bayes Point Machine, which has better generalization properties than Support Vector Machines [Herbrich et al., 2001]. Finally, this work did not examine classification with more than 2 classes. Future implementations could examine this case, where Support Vector Machines may not necessarily be the best choice.

### Relaxation

Unfortunately, the classifier will not correctly predict the labels for all pixels in new unseen test data. However, the classifier evaluated the label of each pixel individually, and did not explicitly consider the dependencies between the labels of neighboring pixels. The goal of the relaxation phase is to correct potential mistakes made by the classifier by considering the labels of spatial neighborhoods of pixels, since neighboring pixels are likely to receive the same value.

Morphological operations such as dilation and erosion are a simple method to do this. A related technique was utilized, which was to apply a median filter to the image constructed from the classifier output. This median filter is repeatedly applied to the discrete pixel labels until no pixels change label between applications of the filter. The effect of this operation is that pixel's labels are made consistent with their neighbors, and boundaries between the two classes are smoothed.

Repeated application of a median filter can only be considered a crude method of relaxation, but it consistently improved or did not change the accuracy of the system in our experiments. There exists a diverse variety of directions to be explored for relaxation in future implementations, primarily focusing on methods that relax ‘soft’ probabilistic labels as opposed to discrete binary labels. These methods obviously depend on having a classifier that outputs probabilistic labels. A simple way to generate probabilistic labels, in the case of Support Vector Machines, is to fit a logistic model to the classifier output (an option included with many Support Vector Machine optimization packages including [Joachims, 1999]).

Given probabilistic labels, several relaxation methods could be explored. The simplest relaxation method would be to smooth the probabilistic labels with a low-pass linear filter before assigning discrete labels. A more sophisticated method could be to use the probabilities to initialize a Level Set active contour to model and constrain the tumor shape, similar to the methods applied in [Ho et al., 2002, Prastawa et al., 2004]. Markov Random Fields can also be used to relax probabilistic class estimates, and were applied previously in the task of tumor segmentation in [Gering, 2003b], which explored the ICM and the mean-field approximation algorithms. Assuming a Gaussian tissue model for the association potential (as in commonly done) would likely not give accurate results, and employing a logistic or non-parametric model may be more appropriate.

Conditional Random Fields are a relatively new formulation of Markov Random Fields that seek to model the data using a discriminative model as opposed to a generative model [Lafferty et al., 2001]. This simplification of the task allows the modeling of more complex dependencies and the use of more powerful parameter estimation and inference methods. Several groups have recently formulated versions of Conditional Random Fields for image data including [Kumar and Hebert, 2003]. Future implementations could explore methods such as these (which would simultaneously perform classification and relaxation).

Yet another method of relaxation that could be explored is to use a sequence of classifiers that train on both the features and the output of previous classifiers (including the predictions for neighboring pixels, or aggregations of these predictions). This would allow dependencies in the labels to be captured by a powerful classification model, while still considering dependencies in the features (in a much more computationally efficient way than in Conditional Random Fields). The disadvantage of this method is that it would require more training data, and its results may still need to be relaxed.

The following are full references to the documents cited in the forgoing, these documents being incorporated herein by reference:
1. [Aldroubi et al., 1992] Aldroubi, A., Unser, M., and Eden, M. (1992). Cardinal spline filters: Stability and convergence to the ideal sinc interpolator. Signal Process, 28(2):127-138.
2. [Alirezaie et al., 1997] Alirezaie, J., Jernigan, M. E., and Nahmias, C. (1997). Neural network based segmentation of magnetic resonance images of the brain. IEEE Transactions on Nuclear Science, 44(2).
3. [Arnold et al., 2001] Arnold, J., Liows, J., Schaper, K., Stem, J., Sled, J., Shattuck, D., Worth, A., Cohen, M., Leahy, R., Mazziotta, J., and Rottenberg, D. (2001). Qualitative and quantitative evaluation of six algorithms for correcting intensity nonuniformity effects. Neuroimage, 13(5):931-943.
4. [Ashburner, 2002] Ashburner, J. (2002). Another mri bias correction approach. In 8th International Conference on Functional Mapping of the Human Brain, Sendai, Japan.
5. [Ashburner and Friston, 1999] Ashburner, J. and Friston, K. (1999). Nonlinear spatial normalization using basis functions. Human Brain Mapping, 7(4):254-266.
6. [Ashburner and Friston, 2003a] Ashburner, J. and Friston, K. (2003a). Morphometry. In Frackowiak, R., Friston, K., Frith, C., Dolan, R., Price, C., Zeki, S., Ashburner, J., and Penny, W., editors, Human Brain Function, chapter 6. Academic Press, 2nd edition.
7. [Ashburner and Friston, 2003b] Ashburner, J. and Friston, K. (2003b). Rigid body registration. In Frackowiak, R., Friston, K., Frith, C., Dolan, R., Price, C., Zeki, S., Ashburner, J., and Penny, W., editors, Human Brain Function, chapter 2. Academic Press, 2nd edition.
8. [Ashburner et al., 1997] Ashburner, J., Neelin, P., Collins, D., Evans, A., and Friston, K. (1997). Incorporating prior knowledge into image registration. NeuroImage, 6(4):344-352.
9. [Barla et al., 2002] Barla, A., Odone, F., and Verri, A. (2002). Hausdorff kernel for 3d object acquisition and detection. In European Conference on Computer Vision.
10. [BrainWeb, Online] BrainWeb (Online). Brainweb: a www interface to a simulated brain database (sbd) and custom mri simulations, http://www.bic.mni.mcgill.ca/brainweb/.
11. [Busch, 1997] Busch, C. (1997). Wavelet based texture segmentation of multi-modal tomographic images. Computer and Graphics, 21(3):347-358.
12. [Capelle et al., 2000] Capelle, A., Alata, O., Fernandez, C., Lefevre, S., and Ferrie, J. (2000). Unsupervised segmentation for automatic detection of brain tumors in mri. In IEEE International Conference on Image Processing, pages 613-616.
13. [Capelle et al., 2004] Capelle, A., Colot, O., and Fernandez-Maloigne, C. (2004). Evidential segmentation scheme of multi-echo MR images for the detection of brain tumors using neighborhood information. Information Fusion, 5(3):203-216.
14. [Carr et al., 2001] Carr, J., Beatson, R., Cherrie, J., Mitchell, T., Fright, W., McCallum, B., and Evans, T. (2001). Reconstruction and representation of 3d objects with radial basis functions. In ACM SIGGRAPH, pages 67-76.
15. [Carr et al., 1997] Carr, J., Fright, W., and Beatson, R. (1997). Surface interpolation with radial basis functions for medical imaging. IEEE Transactions on Medical Imaging, 16(1):96-107.
16. [Choi et al., 1991] Choi, H., Haynor, D., and Kim, Y. (1991). Partial volume tissue classification of multichannel magnetic resonance images-a mixel model. IEEE Transactions on Medical Imaging, 10(3):395-407.
17. [Christenson, 2003] Christenson, J. (2003). Normalization of brain magnetic resonance images using histogram even-order derivative analysis. Magn Reson Imaging, 21(7):817-820.
18. [Clark et al., 1998] Clark, M., Hall, L., Goldgof, D., Velthuizen, R., Murtagh, F., and Silbiger, M. (1998). Automatic tumor segmentation using knowledge-based techniques. IEEE Transactions on Medical Imaging, 17:238-251.
19. [Clarke, 1991] Clarke, L. (1991). Mr image segmentation using mlm and artificial neural nets. Medical Physics, 18(3):673.
20. [Clatz et al., 2004] Clatz, O., Bondiau, P.-Y., Delingette, H., Sermesant, M., Warfield, S., Malandain, G., and Ayache, N. (2004). Brain tumor growth simulation. Technical report, INRIA.
21. [Cocosco et al., 1997] Cocosco, C., Kollokian, V., Kwan, R.-S., and Evans, A. (1997). Brainweb: Online interface to a 3d mri simulated brain database. NeuroImage, 5(S425).
22. [Collignon, 1998] Collignon, A. (1998). Multi-modality medical image registration by maximization of mutual information. PhD thesis, Catholic Univ. Leuven.
23. [Collignon et al., 1995] Collignon, A., Maes, F., Delaere, D., Vandermeulen, D., Sutens, P., and Marchal, G. (1995). Automated multimodality image registration using information theory. In Bizais, Y. and Barillot, C., editors, Information Processing in Medical Imaging, pages 263-274. Kluwer Academic Publishers, Dordrecht.
24. [Collins et al., 1994] Collins, D., Neelin, P., Peters, T., and Evans, A. (1994). Automatic 3d intersubject registration of mr volumetric data in standardized talairach space. J Comput Assist Tomogr, 18(2):192-205.
25. [Collins et al., 1998] Collins, D., Zijdenbos, A., Kollokian, V., Sled, J., Kabani, N., Holmes, C., and Evans, A. (1998). Design and construction of a realistic digital brain phantom. IEEE Transactions on Medical Imaging, 17(3):463-468.
26. [Collowet et al., 2004] Collowet, G., Strzelecki, M., and Mariette, F. (2004). Influence of mri acquisition protocols and image intensity normalization methods on texture classification. Magn Reson Imaging, 22(1):81-91.
27. [Dickson and Thomas, 1997] Dickson, S. and Thomas, B. (1997). Using neural networks to automatically detect brain tumours in MR images. International Journal of Neural Systems, 4(1):91-99.
28. [Evans and Collins, 1993] Evans, A. and Collins, D. (1993). A 305-member mri-based stereotactic atlas for cbf activation studies. In 40th Annual Meeting of the Society for Nuclear Medicine.
29. [Evans et al., 1992a] Evans, A., Collins, D., and Milner, B. (1992a). An mri-bases stereotactic atlas from 250 young normal subjects. In Society for Neuroscience Abstracts, volume 18. Abstract no. 179.4, page 408.
30. [Evans et al., 1992b] Evans, A., Marrett, S., Neelin, P., Collins, L., Worsley, K., Dai, W., Milot, S., Meyer, E., and Bub, D. (1992b). Anatomatical mapping of functional activation in stereotactic coordinate space. Neuroimage, 1(1):43-53.
31. [Fletcher-Heath et al., 2001] Fletcher-Heath, L., Hall, L., Goldgof, D., and Murtagh, F. R. (2001). Automatic segmentation of non-enhancing brain tumors in magnetic resonance images. Artificial Intelligence in Medicine, 21:43-63.
32. [Forsyth and Ponce, 2003] Forsyth, D. and Ponce, J. (2003). Computer Vision: A Modern Approach. Prentice-Hall.
33. [Friston et al., 1995] Friston, K., Ashburner, J., Fristh, C., Poline, J., Heather, J., and Frackowiak, R. (1995). Spatial registration and normalization of images. Human Brain Mapping, 2:165-189.
34. [Garcia and Moreno, 2004] Garcia, C. and Moreno, J. (2004). Kernel based method for segmentation and modeling of magnetic resonance images. Lecture Notes in Computer Science, 3315:636-645.
35. [Gerig et al., 1992] Gerig, G., Kubler, O., Kikinis, R., and Jolesz, F. (1992). Nonlinear anisotropic filtering of mri data. IEEE Transactions on Medical Imaging, 11(2):221-232.
36. [Gering, 2003a] Gering, D. (2003a). Diagonalized nearest neighbor pattern matching for brain tumor segmentation. R. E. Ellis, T. M. Peters (eds), Medical Image Computing and Computer-Assisted Intervention.
37. [Gering, 2003b] Gering, D. (2003b). Recognizing Deviations from Normalcy for Brain Tumor Segmentation. PhD thesis, MIT.
38. [Gibbs et al., 1996] Gibbs, P., Buckley, D., Blackb, S., and Horsman, A. (1996). Tumour volume determination from MR images by morphological segmentation. Physics in Medicine and Biology, 41:2437-2446.
39. [Gispert et al., 2004] Gispert, J., Reig, S., Pascau, J., Vaquero, J., Garcia-Barreno, P., and Desco, M. (2004). Method for bias field correction of brain t1-weighted magnetic resonance images minimizing segmentation error. Hum Brain Mapp., 22(2):133-144.
40. [Gispert et al., 2003] Gispert, J., Reig, S., Pascau, J., Vaquero, M., and Desco, M. (2003). Inhomogeneity correction of magnetic resonance images by minimization of intensity overlapping. In International Conference on Image Processing, volume 2, pages 14-17.
41. [Gosche et al., 1999] Gosche, K., Velthuizen, R., Murtagh, F., Arrington, J., Gross, W., Mortimer, J., and Clarke, L. (1999). Automated quantification of brain magnetic resonance image hyperintensisites using hybrid clustering and knowledge-based methods. International Journal of Imaging Systems and Technology, 10(3):287-293.
42. [Haralick et al., 1973] Haralick, R., Shanmugam, K., and Dinstein, I. (1973). Textural features for image classification. IEEE Trans. on Systems Man and Cybern., SMC-3(6):610-621.
43. [Hastie et al., 2001] Hastie, T., Tibshirani, R., and Friedman, J. (2001). Elements of Statistical Learning: data mining, inference and prediction. Springer-Verlag.
44. [Hayman et al., 2004] Hayman, E., Caputo, B., Fritz, M., and Eklundh, J.-O. (2004). On the significance of real-world conditions for material classification. In 8th ECCV.
45. [Helleslink and Press, 1988] Helleslink, J. and Press, G. (1988). Mr contrast enhancement of intracranial lesions with gd-dtpa. Radiol Clin North Am., 26(4):873-877.
46. [Hellier et al., 2002] Hellier, P., Ashburner, J., Corouge, I., Barillot, C., and Friston, K. (2002). Inter subject registration of functional and anatomical data using spm. In Medical Image Computing and Computer Assisted Intervention, volume 587-590.
47. [Hellier et al., 2001] Hellier, P., Barillot, C., Corouge, I., Gibaud, B., Goualher, G. L., Collins, L., Evans, A., Malandin, G., and Ayache, N. (2001). Retrospective evaluation of inter-subject brain registration. In Viergever, M.-A., Dohi, T., and Vannier, M., editors, Medical Image Computing and Computer-Assisted Intervention, volume 2208, pages 258-265.
48. [Herbrich et al., 2001] Herbrich, R., Graepel, T., and Campbell, C. (2001). Bayes point machines. Journal of Machine Learning Research, 1:245-279.
49. [Herlidou-Meme et al., 2003] Herlidou-Meme, S., Constans, J., Carsin, B., Olivie, D., Eliat, P., Nadal-Desbarats, L., Gondry, C., Rumeur, E. L., Idy-Peretti, I., and de Certaines, J. (2003). Mri texture analysis on texture test objects, normal brain and intracranial tumors. Magnetic Resonance Imaging, 21(9):989-993.
50. [Ho et al., 2002] Ho, S., Bullitt, E., and Gerig, G. (2002). Level set evolution with region competition: automatic 3D segmentation of brain tumors. In 16th International Conference on Pattern Recognition, pages 532-535.
51. [Holmes et al., 1998] Holmes, C., Hoge, R., Collins, L., Woods, R., Toga, A., and Evans, A. (1998). Enhancement of mr images using registration for signal averaging. J Comput Assist Tomogr, 22(2):324-333.
52. [Hornak, 1996] Hornak, J. (1996). The basics of mri, a hypertext book on magnetic resonance imaging. http://www.cis.rit.edu/htbooks/mri/.
53. [ICBM View, Online] ICBM View (Online). Icbm view: an interactive web visualization tool for stereotaxic data from the icbm and other projects, http://www.bic.mni.mcgill.ca/icbmview/.
54. [Joachims, 1999] Joachims, T. (1999). Making large-scale svm learning practical. In Scholkopf, B., Burges, C., and Smola, A., editors, Advances in Kernel Methods—Support Vector Learning. MIT Press.
55. [Joshi et al., 2003] Joshi, S., Lorenzen, P., Gerig, G., and Bullitt, E. (2003). Structural and radiometric asymmetry in brain images. Med Image Anal., 7(2): 155-70.
56. [Just and Thelen, 1988] Just, M. and Thelen, M. (1988). Tissue characterization with T1, T2 and proton density values: Results in 160 patients with brain tumors. Radiology, 169:779-785.
57. [Kaus et al., 2001] Kaus, M., Warfield, S., Nabavi, A., Black, P., Jolesz, F., and Kikinis, R. (2001). Automated segmentation of MR images of brain tumors. Radiology, 218:586-591.
58. [Kjaer et al., 1995] Kjaer, L., Ring, P., Thomsen, C., and Henriksen, O. (1995). Texture analysis in quantitative mr imaging. tissue characterisation of normal brain and intracranial tumours at 1.5 t. Acta Radiol, 36(2):127-135.
59. [Kumar and Hebert, 2003] Kumar, S. and Hebert, M. (2003). Discriminative random fields: A discriminative framework for contextual interaction in classification. In IEEE Conf. on Computer Vision and Pattern Recognition.
60. [Kwan et al., 1996] Kwan, R.-S., Evans, A., and Pike, G. (1996). An extensible mri simulator for post-processing evaluation. Lecture Notes in Computer Science, 1131(11):135-140.
61. [Kwan et al., 1999] Kwan, R.-S., Evans, A., and Pike, G. (1999). Mri simulation-based evaluation of image-processing and classification methods. IEEE Transactions on Medical Imaging, 18(11):1085-1097.
62. [Lafferty et al., 2001] Lafferty, J., Pereira, F., and McCallum, A. (2001). Conditional random fields: Probabilistic models for segmenting and labeling sequence data. In International Conference on Machine Learning.
63. [Lee et al., 1997] Lee, S., Wolberg, G., and Shin, S. (1997). Scattered data interpolation with multilevel B-splines. IEEE Transactions on Visualization and Computer Graphics, 3(3):228-244.
64. [Leemput et al., 1999a] Leemput, K., Maes, F., Vandermeulen, D., and Suetens, P. (1999a). Automated model-based tissue classification of MR images of the brain. IEEE Transactions on Medical Imaging, 18(10):897-908.
65. [Leemput et al., 1999b] Leemput, K., Mase, F., Vandermeulen, D., and Suentens, P. (1999b). Automated model-based bias field correction of mr images of the brain. IEEE Transactions on Medical Imaging, 18(10):885-896.
66. [Lehmann et al., 1999] Lehmann, T., Gonner, C., and Spitzer, K. (1999). Survey: interpolation methods in medical image processing. IEEE Transactions on Medical Imaging, 18(11):1049-1075.
67. [Leung and Malik, 2001] Leung, T. and Malik, J. (2001). Representing and recognizing the visual appearance of materials using three-dimensional textons. International Journal of Computer Vision, 43(1):29-44.
68. [Leung et al., 2001] Leung, W., Bones, P., and Lane, R. (2001). Statistical interpolation of sampled images. Optical Engineering, 40(4):547-553.
69. [Likar et al., 2001] Likar, B., Viergever, M., and Pernus, F. (2001). Retrospective correction of mr intensity inhomogeneity by information minimization. IEEE Transactions on Medical Imaging, 20(12):1398-1410.
70. [Ling and Bovik, 2002] Ling, H. and Bovik, A. (2002). Smoothing low-snr molecular images via anisotropic median-diffusion. IEEE Transactions on Medical Imaging, 21(4):377-384.
71. [Liu et al., 2001] Liu, Y., Collins, R., and Rothfus, W. (2001). Robust midsaggital plane extraction from normal and pathological 3d neuroradiology images. IEEE Transactions on Medical Imaging, 20(3): 175-192.
72. [M. Ozkan, 1993] M. Ozkan, B. M. Dawant, R. M. (1993). Neural-network-based segmentation of multi-modal medical images: a comparative and prospective study. IEEE Transactions on Medical Imaging, 12(3):534-544.
73. [Madabhushi and Udupa, 2002] Madabhushi, A. and Udupa, J. (2002). Evaluating intensity standardization and inhomogeneity correction in magnetic resonance images. In IEEE 28th Annual Northeast Bioengineering Conference, pages 137-138.
74. [Mahmoud-Ghoenim et al., 2003] Mahmoud-Ghoenim, D., Toussaint, G., Constans, J.-M., and de Certaines, J. (2003). Three dimensional texture analysis in mri: a preliminary evaluation in gliomas. Magnetic Resonance Imaging, 21(9):983-987.
75. [Maintz and Viergever, 1998] Maintz, J. and Viergever, M. (1998). An overview of medical image registration methods. Medical Image Analysis, 2:1-36.
76. [Mangin, 2000] Mangin, J.-F. (2000). Entropy minimization for automatic correction of intensity nonuniformity. In IEEE Workshop on Mathematical Methods in Biomedical Image Analysis, pages 162-169.
77. [Materka and Strzelecki, 1998] Materka, A. and Strzelecki, M. (1998). Texture analysis methods—a review. Technical report, COST B11 Technical Reports, Brussels.
78. [MATLAB, Online] MATLAB (Online). Matlab—the language of technical computing, http://www.mathworks.com/products/matlab/.
79. [Mazzara et al., 2004] Mazzara, G., Velthuizen, R., Pearlman, J., Greenberg, H., and Wagner, H. (2004). Brain tumor target volume determination for radiation treatment planning through automated mri segmentation. International Journal of Radiation Oncology*Biology*Physics, 59(1):300-312.
80. [Mazziotta et al., 2001] Mazziotta, J., Toga, A., Evans, A., Fox, P., Lancaster, J., Zilles, K., Woods, R., Paus, T., Simpson, G., Pike, B., Holmes, C., Collins, L., Thompson, P., MacDonald, D., Iacoboni, M., Schormann, T., Amunts, K., Palomero-Gallagher, N., Geyer, S., Parsons, L., Narr, K., Kabani, N., Goualher, G. L., Boomsma, D., Cannon, T., Kawashima, R., and Mazoyer, B. (2001). A probabilistic atlas and reference system for the human brain: International consortium for brain mapping (icbm). Philosophical Transactions: Biological Sciences, 356(1412):1293-1322.
81. [McClain et al., 1995] McClain, K., Zhu, Y., and Hazle, J. (1995). Selection of MR images for automated segmentation. Journal of Magnetic Resonanse Imaging, 5(5):485-492.
82. [Meijering, 2002] Meijering, E. (2002). A chronology of interpolation: From ancient astronomy to modern signal and image processing. Proceedings of the IEEE, 90(3):319-342.
83. [Meijering et al., 2001] Meijering, E., Niessen, W., and Viergever, M. (2001). Quantitative evaluation of convolution-based methods for medical image interpolation. Med. Image Anal., 5(2):111-126.
84. [Miller et al., 1981] Miller, A., Hoogstraten, B., Staquet, M., and Winkler, M. (1981). Reporting results of cancer treatment. Cancer, 47:207-214.
85. [MIPAV, Online] MIPAV (Online). Medical image processing, analysis and visualization, http://mipav.cit.nih.gov/.
86. [Moler, 2002] Moler, C. (2002). Numerical computing with Matlab. http://www.mathworks.com/moler/.
87. [Moon et al., 2002] Moon, N., Bullitt, E., Leemput, K., and Gerig, G. (2002). Automatic Brain and Tumor Segmentation, pages 372-379. T. Dohi, R. Kikinis, eds. Medical Image Computing and Computer-Assisted Intervention. Springer, Tokyo, Japan.
88. [Murray, 2003] Murray, J. (2003). Mathematical Biology II: Spatial Models and Biomedical Applications. Springer-Verlag, 3rd edition.
89. [Muzzolini et al., 1998] Muzzolini, R., Yang, Y., and Pierson, R. (1998). Classifier design with incomplete knowledge. Pattern Recognition, 31(4):345-369.
90. [Nyul and Udupa, 1999] Nyul, L. and Udupa, J. (1999). On standardizing the mr image intensity scale. Magn Reson Med, 42(6):1072-1081.
91. [Nyul et al., 2000] Nyul, L., Udupa, J., and Zhang, X. (2000). New variants of a method of mri scale standardization. IEEE Transactions on Medical Imaging, 19(2):143-150.
92. [O'Donnell, 2001] O'Donnell, L. (2001). Semi-automatic medical image segmentation. Master's thesis, MIT.
93. [Otsu, 1979] Otsu, N. (1979). A threshold selection method from gray-level histograms. IEEE Trans. Systems, Man adn Cybernetics, 9(1):62-66.
94. [Peck et al., 2001] Peck, D., Hearshen, D., Soltanian-Zadeh, H., Scarpace, L., Dodge, C., and Mikkelsen, T. (2001). Segmentation of brain tumor boundaries using pattern recognition of magnetic resonance spectroscopy. In RSNA.
95. [Perona and Malik, 1990] Perona, P. and Malik, J. (1990). Scale-space and edge detection using anisotropic diffusion. IEEE Transactions on Pattern Analysis and Machine Intelligence, 12(7):629-639.
96. [Pirzkall et al., 2001] Pirzkall, A., McKnight, T., Graves, E., Carol, M., Sneed, P., Wara, W., Nelson, S., Verhey, L., and Larson, D. (2001). Mr-spectroscopy guided target delineation for high-grade gliomas. International Journal of Radiation Oncology*Biology*Physics, 50(4):915-928.
97. [Platt, 1999] Platt, J. (1999). Fast training of support vector machines using sequential minimal optimization. In Scholkopf, B., Burges, C., and Smola, A., editors, Advances in Kernel Methods—Support Vector Learning, pages 185-208. MIT Press.
98. [Pluim et al., 2003] Pluim, J., Maintz, J., and Viergever, M. (2003). Mutual-information-based registration of medical images: a survey. IEEE Transactions on Medical Imaging, 22(8):986-1004.
99. [Prastawa et al., 2004] Prastawa, M., Bullitt, E., Ho, S., and Gerig, G. (2004). A brain tumor segmentation framework based on outlier detection. Medical Image Analysis, 8(3):275-283.
100. [Prastawa et al., 2003] Prastawa, M., Bullitt, E., Moon, N., Leemput, K., and Gerig, G. (2003). Automatic brain tumor segmentation by subject specific modification of atlas priors. Academic Radiology, 10(12):1341-1348.
101. [Price et al., 2004] Price, S., Pena, A., Burnet, N., Jena, R., Green, H., Carpenter, T., Pickard, J., and Gillard, J. (2004). Tissue signature characterization of diffusion tensor abnormalities in cerebral gliomas. In Workshop on Advances in Experimental and Clinical MR in Cancer Research.
102. [Quinlan, 1993] Quinlan, J. (1993). C4.5: programs for machine learning. Mogran Kaufmann Publishers Inc.
103. [Randen and Husoy, 1999] Randen, T. and Husoy, J. (1999). Filtering for texture classification: a comparative study. IEEE Transactions on Pattern Analysis and Machine Intelligence, 21(4):291-310.
104. [Russell and Norvig, 2002] Russell, S. and Norvig, P. (2002). Artificial Intelligence: A Modern Approach. Prentice Hall, 2nd edition.
105. [Sammouda et al., 1996] Sammouda, R., Niki, N., and Nishitani, H. (1996). A comparison of hopfield neural network and boltzmann machine in segmenting mr images of the brain. IEEE Transactions on Nuclear Science, 43(6):3361-3369.
106. [Schad et al., 1993] Schad, L., Bluml, S., and Zuna, I. (1993). MR tissue characterization of intracranial tumors by means of texture analysis. Magnetic Resonance Imaging, 11(6):889-896.
107. [Shattuck et al., 2001] Shattuck, D., Sandor-Leahy, S., Schaper, K., Rottenberg, D., and Leahy, R. (2001). Magnetic resonance image tissue classification using a partial volume model. Neuroimage, 13(5):856-876.
108. [Shawe-Taylor and Cristianini, 2004] Shawe-Taylor, J. and Cristianini, N. (2004). Kernel Methods for Pattern Analysis. Cambridge University Press.
109. [Shen et al., 2003] Shen, S., Sandham, W., and Granat, M. (2003). Pre-processing and segmentation of brain magnetic resonance images. In 4th International IEEE EMBS Specific Topic Conference on Information Technology Applications in Biomedicine, pages 149-152.
110. [Simmons et al., 1994] Simmons, A., Tofts, P., Barker, G., and Arridge, S. (1994). Sources of intensity nonuniformity in spin echo images at 1.5 t. Magn Reson Med, 32(1):121-128.
111. [Sled, 1997] Sled, J. (1997). A nonparametric method for automatic correction of intensity nonuniformity in MRI data. PhD thesis, McGill University.
112. [Sled et al., 1999] Sled, J., Zijdenbos, A., and Evans, A. (1999). A nonparametric method for automatic correction of intensity nonuniformity in MRI data. IEEE Transactions on Medical Imaging, 17:87-97.
113. [Smith and Brady, 1997] Smith, S. and Brady, J. (1997). Susan—a new approach to low level image processing. Int. Journal of Computer Vision, 23(1):45-78.
114. [Soltanian-Zadeh et al., 1998] Soltanian-Zadeh, H., Peck., D., Windham, J., and Mikkelsen, T. (1998). Brain tumor segmentation and characterization by pattern analysis of multispectral nmr images. NMR Biomed, 11(4-5):201-208.
115. [Soltanian-Zadeh et al., 2004] Soltanian-Zadeh, H., Rafiee-Rad, F., and D, S. P.-N. (2004). Comparison of multiwavelet, wavelet, haralick, and shape features for microcalcification classification in mammograms. Pattern Recognition, 37(10):1973-1986.
116. [SPM, Online] SPM (Online). Statistical parametric mapping, http://www.fil.ion.bpmf.ac.uk/spm/.
117. [Stadlbauer et al., 2004] Stadlbauer, A., Moser, E., Gruber, S., Buslei, R., Nimsky, C., Fahlbusch, R., and Ganslandt, O. (2004). Improved delineation of brain tumors: an automated method for segmentation based on pathologic changes of 1 h-mrsi metabolites in gliomas. Neuroimage, 23(2):454-461.
118. [Studholme et al., 2004] Studholme, C., Cardenas, V., Song, E., Ezekiel, F., Maudsley, A., and Wiener, M. (2004). Accurate template-based correction of brain mri intensity distortion with application to dementia and aging. IEEE Transactions on Medical Imaging, 23(1):99-110.
119. [Studholme et al., 1998] Studholme, C., Hawkes, D., and Hill, D. (1998). A normalized entropy measure of 3-d medical image alignment. In Medical Imaging, volume 3338, pages 132-143.
120. [Talairach and Tourneaux, 1988] Talairach, J. and Tourneaux, P. (1988). Co-planar Stereotaxic Atlas of the Human Brain: 3-Dimensional Proportional System—an Approach to Cerebral Imaging. Thieme Medical Publishers.
121. [TD, Online] TD (Online). Talairach daemon applet, http://ric.uthscsa.edu/tdapplet/.
122. [Therasse et al., 2000] Therasse, P., Arbuck, S., Eisenhauer, E., Wanders, J., Kaplan, R., Rubinstein, L., and et al. (2000). New guidelines to evaluate the response to treatment in solid tumors. J Natl Cancer Inst, 92:205-216.
123. [Thevenaz et al., 2000] Thevenaz, P., Blu, T., and Unser, M. (2000). Interpolation revisited [medical images application]. IEEE Transactions on Medical Imaging, 19(7):738-758.
124. [Toga et al., 2003] Toga, A., Thompson, P., Narr, K., and Sowell, E. (2003). Probabilistic brain atlases or normal and diseased populations. In Koslow, S. and Subramaniam, S., editors, Databasing the Brain: From Data to Knowledge (Neuroinformatics). John Wiley & Sons, Inc.
125. [Tuceryan and Jain, 1998] Tuceryan, M. and Jain, A. (1998). Texture analysis. In Chen, C., Pau, L., and Wang, P., editors, The Handbook of Pattern Recognition and Computer Vision, pages 207-248. World Scientific Publishing Co.
126. [Tzourio-Mazoyer and et al., 2002] Tzourio-Mazoyer, N. and et al. (2002). Automated anatomical labelling of activations in spm using a macroscopic anatomical parcellation of the mni mri single subject brain. Neuroimage, 15:273-289.
127. [Unser et al., 1991] Unser, M., Aldroubi, A., and Eden, M. (1991). Fast B-spline transforms for continuous image representation and interpolation. IEEE Trans. Pattern Anal. Machine Intell., 13:277-285.
128. [Unser et al., 1992] Unser, M., Aldroubi, A., and Eden, M. (1992). Polynomial spline signal approximations: Filter design and asymptotic equivalence with shannon's sampling theorum. IEEE Trans. Inform. Theory, 38:95-103.
129. [Varma and Zesserman, 2002] Varma, M. and Zesserman, A. (2002). Classifying images of materials: Achieving viewpoint and illumination independence. Lecture Notes in Computer Science, 2352:255-271.
130. [Varma and Zisserman, 2003] Varma, M. and Zisserman, A. (2003). Texture classification: are filters banks necessary? In IEEE Computer Society Conference on Computer Vision and Pattern Recognition, volume 2, pages 18-20.
131. [Velthuizen et al., 1998] Velthuizen, R., Heine, J., Cantor, A., Lin, H., Fletcher, L., and Clarke, L. (1998). Review and evaluation of mri nonuniformity corrections for brain tumor response measurements. Med Phys, 25(9): 1655-66.
132. [Vinitski et al., 1997] Vinitski, S., Gonzalez, C., Mohamed, F., Iwanaga, T., Knobler, R., Khalili, K., and Mack, J. (1997). Improved intracranial lesion characterization by tissue segmentation based on a 3D feature map. Magnetic Resonance in Medicine, 37:457-469.
133. [Viola, 1995] Viola, P. (1995). Alignment by Maximization of Mutual Information. PhD thesis, MIT.
134. [Vokurka et al., 1999] Vokurka, E., Thacker, N., and Jackson, A. (1999). A fast model independent method for automatic correction of intensity non-uniformity in mri data. JMRI, 10(4):550-562.
135. [Vovk et al., 2004] Vovk, U., Pernus, F., and Likar, B. (2004). Mri intensity inhomogeneity correction by combining intensity and spatial information. Physics in Medicine and Biology, 49(17):4119-4133(15).
136. [Wang et al., 1998] Wang, L., Lai, H., Barker, G., Miller, D., and Tofts, P. (1998). Correction for variations in mri scanner sensitivity in brain studies with histogram matching. Magn Reson Med, 39(2):322-327.
137. [Weisenfeld and Warfield, 2004] Weisenfeld, N. and Warfield, S. (2004). Normalization of joint image-intensity statistics in mri using the kullback-leibler divergence. In IEEE International Symposium on Biomedical Imaging.
138. [Wells et al., 1996] Wells, W., Kikinis, R., Grimson, W., and Jolesz, F. (1996). Adaptive segmentation of MRI data. IEEE Transactions on Medical Imaging.
139. [Wells et al., 1995] Wells, W., Viola, P., and Kikinis, R. (1995). Multi-modal volume registration by maximization of mutual information. In Medical Robotics and Computer Assisted Surgery, pages 55-62. Wiley.
140. [West et al., 1997] West, J., Fitzpatrick, J., Wang, M., Dawant, B., Jr., C. M., Kessler, R., Maciunas, R., Barillot, C., Lemoine, D., Collignon, A., Maes, F., Suetens, P., Vandermeulen, D., van den Elsen, P., Napel, S., Sumanaweera, T., Harkness, B., Hemler, P., Hill, D., Hawkes, D., C. Studholme, Maintz, J., Viergever, M., Malandin, G., Pennec, X., Noz, M., Jr., G. M., Pollack, M., Pelizzari, C., Robb, R., Hanson, D., and Woods, R. (1997). Comparison and evaluation of retrospective intermodality image registration techniques. J. Comput. Assisted Tomogr., 21:554-566.
141. [Yoon et al., 1999] Yoon, O.-K., Kwak, D.-M., Kim, D.-W., and Park, K.-H. (1999). Mr brain image segmentation using fuzzy clustering. In Fuzzy Systems Conference Proceddings, 1999. FUZZ-IEEE '99. 1999 IEEE International, volume 2, pages 853-857.
142. [Zhang et al., 2004] Zhang, J., Ma, K., Er, M., and Chong, V. (2004). Tumor segmentation from magnetic resonance imaging by learning via one-class support vector machine. International Workshop on Advanced Image Technology, pages 207-211.
143. [Zhu and Yan, 1997] Zhu, Y. and Yan, H. (1997). Computerized tumor boundary detection using a hopfield neural network. IEEE Transactions on Medical Imaging, 16:55-67.
144. [Zijdenbos et al., 1995] Zijdenbos, A., Dawant, B., and Margolin, R. (1995). Intensity correction and its effect on measurement variability in mri. In Computer Assisted Radiology.
145. [Zijdenbos et al., 1998] Zijdenbos, A., Forghani, R., and Evans, A. (1998). Automatic quantification of MS lesions in 3D MRI brain data sets: Validation of INSECT. Medical Image Computing and Computer-Assisted Intervention, pages 439-448.
146. [Zijdenbos et al., 2002] Zijdenbos, A., Forghani, R., and Evans, A. (2002). Automatic “pipeline” analysis of 3-d mri data for clinical trials: application to multiple sclerosis. IEEE Transactions on Medical Imaging, 21(10):1280-1291.

In accordance with one embodiment of the present invention, there is provided a method for segmenting objects in one or more original images, comprising: processing the one or more original images to increase intensity standardization within and between the images; aligning the images with one or more template images; extracting features from both the original and template images; and combining the features through a classification model to thereby segment the objects.

In accordance with another embodiment of the present invention, there is a provided in a data processing system, a method for segmenting an object represented in one or more images, each of the one or more images comprising a plurality of pixels, the method comprising the steps of: measuring image properties or extracting image features of the one or more images at a plurality of locations; measuring image properties or extracting image features of one or more template images at a plurality of locations corresponding to the same locations in the one or more images, each of the template images comprising a plurality of pixels; and classifying each pixel, or a group of pixels, in the one or more images based on the measured properties or extracted features of the one or more images and the one or more template images in accordance with a classification model mapping image properties or extracted features to respective classes so as to segment the object represented in the one or more images according to the classification of each pixel or a group of pixels.

In accordance with a further embodiment of the present invention, there is provided in a data processing system, a method for segmenting an object represented in one or more input images, each of the one or more input images comprising a plurality of pixels, the method comprising the steps of: aligning the one or more input images with one or more corresponding template images each comprising a plurality of pixels; extracting features of each of the one or more input images and one or more template images; and classifying each pixel, or a group of pixels, in the one or more input images based on the extracted features of the one or more input images and the one or more corresponding template images in accordance with a classification model mapping image properties or features to a respective class so as to segment the object in the one or more input images according to the classification of each pixel or group of pixels.

The method may further comprise relaxing the classification of each pixel or group of pixels. The relaxing may comprise reclassifying each pixel or group of pixels in the one or more input images in accordance with the classification or extracted features of other pixels in the one or more input images so as to take into account the classification or extracted features of the other pixels in the one or more input images. Alternatively, the relaxing may comprise reclassifying each pixel or group of pixels in the one or more input images in accordance with the classification of surrounding pixels in the one or more input images so as to take into account the classification of the surrounding pixels in the one or more input images. The reclassifying may comprise applying a spatial median filter over the classifications of each pixel or group of pixels such that the classification of each pixel is consistent with the classification of the surrounding pixels in the one or more input images.

The extracted features may be based on one or more pixels in the respective one or more input and template images. The extracted features may be based on individual pixels in the respective one or more input and template images.

The classification model may define a classification in which each pixel or group of pixels representing the object in the one or more input images is classified as belonging to one of two or more classes defined by the classification model. The classification model may define a binary classification in which each pixel or group of pixels representing the object in the one or more input images is classified as belonging to either a “normal” class or an “abnormal” class defined by the classification model.

The extracted features may be one or more of: image-based features based on measurable properties of the one or more input images or corresponding signals; coordinate-based features based on measurable properties of a coordinate reference or corresponding signals; registration-based features based on measurable properties of the template images or corresponding signals. Preferably, the extracted features comprise image-based, coordinate-based and registration-based features. The image-based features may comprise one or more of: intensity features, texture features, histogram-based features, and shape-based features. The coordinate-based features may comprise one or more of: measurable properties of the coordinate reference; spatial prior probabilities for structures or object subtypes in coordinate reference; and local measures of variability within the coordinate reference. The registration-based features may comprise one or more of: features based on identified regions in the template images; measurable properties at the template images; features derived from a spatial transformation of the one or more input images; and features derived from a line of symmetry of the one or more template images. If the wherein the one or more input images is a medical image, the coordinate-based features may be spatial prior probabilities for structures or tissue types in coordinate reference and local measures of anatomic variability within the coordinate reference.

The method may further comprise before aligning the images, reducing intensity inhomogeneity within and/or between the one or more input images or reducing noise in the one or more input images. The step of reducing intensity inhomogeneity may comprise one or more of the steps of: two-dimensional noise reduction comprising reducing local noise within the input images; inter-slice intensity variation reduction comprising reducing intensity variations between adjacent images in an image series formed by the input images; intensity inhomogeneity reduction for reducing gradual intensity changes over the image series; and three-dimensional noise reduction comprising reducing local noise between over the image series. The two-dimensional noise reduction may comprise applying edge-preserving and/or edge-enhancing smoothing methods such as applying a two-dimensional Smallest Univalue Segment Assimilating Nucleus (SUSAN) filter to the images. The three-dimensional noise reduction may comprise applying edge-preserving and/or edge-enhancing smoothing methods such as applying a three-dimensional SUSAN filter to the image series. The step of intensity inhomogeneity reduction may comprise Nonparametric Nonuniform intensity Normalization (N3).

The method may further comprise standardizing the intensity of the one or more input images. The intensity of the one or more input images may be standardized relative to the template image intensities, or may be standardized collectively so as to increase a measured similarity between the one or more input images.

The steps of two-dimensional noise reduction, inter-slice intensity variation reduction, intensity inhomogeneity reduction, three-dimensional noise reduction, and intensity standardization, where they all occur, are preferably performed sequentially.

The step of aligning the one or more input images with one or more template images may comprise: spatially aligning the one or more input images with one or more corresponding template images in accordance within a standard coordinate system such that the object represented in the one or more input images is aligned with a template object in the one or more template images; spatially transforming the one or more input images to increase correspondence in shape of the object represented in the one or more input images with the template object in the one or more template images (i.e. so as to more closely conform to a volume of the imaged object represented over the image series); and spatially interpolating the one or more input images so as that the pixels in the spatially transformed one or more input images have the same size and spatially correspond to the pixels in the one or more template images in accordance with the standard coordinate system. Preferably, the steps of spatially aligning, spatially transforming, and spatially interpolating are performed sequentially. The method may further comprise, before spatially aligning the one or more input images with the one or more template images, spatially aligning and/or spatially transforming the one or more input images so to align the object represented in the one or more input images with each another.

The one or more input images may be images generated by a magnetic resonance imaging procedure or medical imaging procedure. The one or more input images may include at least one of: medical imaging images, magnetic resonance images, magnetic resonance T1-weighted images, magnetic resonance T2-weighted images, magnetic resonance spectroscopy images, and anatomic images. The one or more input images may comprise an image series of cross-sectional images taken in a common plane and offset with respect to one another so as to represent a volume, the one or more input images being arranged in the image series so as to spatially correspond to the respective cross-sections of the volume.

The object represented in the one or more input images may be a visual representation of a brain, the classification model segmenting the visual representation of the brain into objects that include at least one of: tumors, edema, lesions, brain tumors, brain edema, brain lesions, multiple sclerosis lesions, areas of stroke, and areas of brain damage.

The method may further comprise presenting a visual representation of the classification of each pixel or group of pixels on a display of the data processing system. The visual representation may be provided by colour-coding each pixel or group of pixels in accordance with its respective classification, or delineating each pixel or group of pixels in accordance with its respective classification.

The method may further comprise outputting or transmitting a computer data signal containing computer-execute code for presenting a visual representation of the classification of each pixel or group of pixels on a display device.

The method may classify each pixel separately rather than in groups.

In accordance with a further embodiment of the present application, there is provided a data processing system for segmenting one or more input images into objects, each of the one or more input images each comprising a plurality of pixels, the data processing system comprising: a display, one or more input devices, a memory, and a processor operatively connected to the display, input devices, and memory; the memory having data and instructions stored thereon to configure the processor to perform the above-described method.

In accordance with a further embodiment of the present application, there is provided a computer-readable medium carrying data and instructions for programming a data processing system to perform the above-described method.

The present invention provides a method and system in which direct processing of MRI image data may be performed to reduce the effects of MRI image intensity inhomogeneities. To make the method robust to the problems associated with segmenting tumors and edema and to further reduce the problems associated with MRI intensity inhomogeneities, the segmentation is performed through the combination of information from various sources (e.g. intensity, texture, normal tissue spatial priors, measures of anatomic variability, bi-lateral symmetry, multi-spectral distances to normal intensities, etc.). In contrast to the approach of Gosche, the present invention uses general “anatomy-based features” and uses pattern recognition techniques to learn what constitutes a tumor based on these features and images that have been labelled by a human expert.

The present invention may be used in the automatic detection and segmentation of brain tumors and associated edema from MRI, a challenging pattern recognition task. Existing automatic methods to perform this task in more difficult cases are insufficient due to the large amount of variability observed in brain tumors and the difficulty associated with using the intensity data directly to discriminate between normal and abnormal regions. Existing methods thus focus on simplified versions of this task, or require extensive manual initialization for each scan to be segmented. According to some embodiments, the method of the present invention does not need manual initialization for each scan to be segmented, and is able to simultaneously learn to combine information from diverse sources in order to address challenging cases where ambiguity exists based on the intensity information alone.

The problem sought to be solved represents a complex pattern recognition task which involves simultaneously considering the observed image data and prior anatomic knowledge. The system provided by the present invention uses a variety of features derived from the registration of a template image in order to approximate this knowledge. These diverse forms of potential evidence for tumors are combined simultaneously with features measured directly from the observed image or derived from measures of the image using a classification model, which finds meaningful combinations of the features in order to optimize a performance measure.

The present invention extracts features from both the image and template registration (that may use a standard coordinate system to add additional features), and combines the features with a classification model. Using these features, diverse sources of information may be used to detect for the presence of tumors or edema, including more than a single type of registration-based feature. Existing methods have attempted to combine intensity with texture data, intensity with spatial prior probabilities, intensity with symmetry, and intensity with distances to template labels. However, according to some embodiments of the present invention, it possible to simultaneously consider intensity, texture, spatial prior probabilities, symmetry, and distances to template labels. In addition, the use of a classification model allows additional sources of evidence to be easily added, including measurements of anatomic variability, template image information, features measuring conformance to a tissue model, shape properties, and other measures. The use of a larger combination of features allows higher classification accuracy than with the smaller subsets of existing methods.

The present invention also allows the incorporation of a large amount of prior knowledge (e.g. anatomical and pathological knowledge in medical applications) into the process through the use of multiple registration-based features, while the use of a classification model in turn alleviates the need to perform the significant modality-dependent, task-dependent, and machine-dependent manual engineering required to use find effective ways of using this prior knowledge. This is in contrast to existing methods which either incorporate very limited forms of prior knowledge and therefore achieve less accurate results, or methods that use significant manually encoded prior knowledge (not considering them simultaneously or in a way that necessarily maximizes a performance measure), but are only designed for very specific (and simplified) tasks without the ability to easily adapt the methods to related tasks. These latter methods cannot take advantage of newer and more powerful protocols without complete redesign. In contrast, the method of the present invention simply requires training examples of normal and abnormal areas in the new modality in order to take advantage of it.

While this invention is primarily discussed as a method, a person of ordinary skill in the art will understand that the apparatus discussed above with reference to a data processing system, may be programmed to enable the practice of the method of the invention. Moreover, an article of manufacture for use with a data processing system, such as a pre-recorded storage device or other similar computer readable medium including program instructions recorded thereon, may direct the data processing system to facilitate the practice of the method of the invention. Further, a computer data signal having program instructions recorded therein, may direct the data processing system to facilitate for practice of the method of the invention. It is understood that such apparatus, articles of manufacture, and computer data signals also come within the scope of the invention.

The embodiments of the invention described above are intended to be examples only. Those of skill in the art may effect alterations, modifications and variations to the particular embodiments without departing from the scope of the invention. The subject matter described herein in the recited claims intends to cover and embrace all suitable changes in technology.

1. In a data processing system, a method for segmenting an object represented in one or more input images, each of the one or more input images comprising a plurality of pixels, the method comprising the steps of:
aligning the one or more input images with one or more corresponding template images each comprising a plurality of pixels;
extracting features of each of the one or more input images and one or more template images; and
classifying each pixel, or a group of pixels, in the one or more input images based on the extracted features of the one or more input images and the one or more corresponding template images in accordance with a classification model mapping image properties or features to a respective class so as to segment the object represented in the one or more input images according to the classification of each pixel or group of pixels.

2. The method of claim 1, further comprising relaxing the classification of each pixel or group of pixels.

3. The method of claim 2, wherein the relaxing comprises reclassifying each pixel or group of pixels in the one or more input images in accordance with the classification or extracted features of other pixels in the one or more input images so as to take into account the classification or extracted features of the other pixels in the one or more input images.

4. The method of claim 2, wherein the relaxing comprises reclassifying each pixel or group of pixels in the one or more input images in accordance with the classification of surrounding pixels in the one or more input images so as to take into account the classification of the surrounding pixels in the one or more input images.

5. The method of claim 4, wherein the reclassifying comprises applying a spatial median filter over the classifications of each pixel or group of pixels such that the classification of each pixel is consistent with the classification of the surrounding pixels in the one or more input images.

6. The method of claim 1, wherein the extracted features are based on one or more pixels in the respective one or more input and template images.

7. The method of claim 1, wherein the extracted features are based on individual pixels in the respective one or more input and template images.

8. The method of claim 1, wherein the classification model defines a classification in which each pixel or group of pixels representing the object in the one or more input images is classified as belonging to one of two or more classes defined by the classification model.

9. The method of claim 1, wherein the classification model defines a binary classification in which each pixel or group of pixels representing the object in the one or more input images is classified as belonging to either a “normal” class or an “abnormal” class defined by the classification model.

10. The method of claim 1, wherein the features are one or more of: image-based features based on measurable properties of the one or more input images or corresponding signals; coordinate-based features based on measurable properties of a coordinate reference or corresponding signals; registration-based features based on measurable properties of the template images or corresponding signals.

11. The method of claim 1, wherein the extracted features are image-based features based on measurable properties of the one or more input images; coordinate-based features based on measurable properties of a coordinate reference; and registration-based features based on measurable properties of the template images.

12. The method of claim 10, wherein the image-based features comprise one or more of: intensity features, texture features, histogram-based features, and shape-based features.

13. The method of claim of claim 10, wherein the coordinate-based features comprises one or more of: measurable properties of the coordinate reference; spatial prior probabilities for structures or object subtypes in coordinate reference; and local measures of variability within the coordinate reference.

14. The method of claim 10, wherein the one or more input images are medical images, the coordinate-based features comprising one or more of: measurable properties of the coordinate reference, spatial prior probabilities for structures or tissue types in coordinate reference, and local measures of anatomic variability within the coordinate reference.

15. The method of claim 10, wherein the registration-based features comprises one or more of: features based on identified regions in the template images; measurable properties at the template images; features derived from a spatial transformation of the one or more input images; and features derived from a line of symmetry of the one or more template images.

16. The method of claim 1, further comprising, before the aligning step, the step of reducing intensity inhomogeneity within and/or between the one or more input images.

17. The method of claim 1, further comprising, before the aligning step, the step of reducing noise in the one or more input images.

18. The method of claim 16, wherein the step of reducing intensity inhomogeneity comprises one or more of the steps of: two-dimensional noise reduction comprising reducing local noise within the input images; inter-slice intensity variation reduction comprising reducing intensity variations between adjacent images in an image series formed by the input images; intensity inhomogeneity reduction for reducing gradual intensity changes over the image series; and three-dimensional noise reduction comprising reducing local noise between over the image series.

19. The method of claim 18, wherein the two-dimensional noise reduction comprises applying edge-preserving and/or edge-enhancing smoothing methods.

20. The method of claim 18, wherein the two-dimensional noise reduction comprises applying a two-dimensional Smallest Univalue Segment Assimilating Nucleus (SUSAN) filter to the images.

21. The method of claim 18, wherein the three-dimensional noise reduction comprises applying edge-preserving and/or edge-enhancing smoothing methods.

22. The method of claim 18, wherein the three-dimensional noise reduction comprises applying a three-dimensional SUSAN filter to the image series.

23. The method of claim 18, wherein the step of intensity inhomogeneity reduction comprises Nonparametric Nonuniform intensity Normalization (N3).

24. The method of claim 18, further comprising standardizing the intensity of the one or more input images.

25. The method of claim 24, wherein the intensity of the one or more input images is standardized relative to the template image intensities.

26. The method of claim 24, wherein the intensity of the input images is standardized collectively so as to increase a measured similarity between the one or more input images.

27. The method of claim 24, wherein the steps of two-dimensional noise reduction, inter-slice intensity variation reduction, intensity inhomogeneity reduction, three-dimensional noise reduction, and intensity standardization are performed sequentially.

28. The method of claim 1, wherein the step of aligning the one or more input images with one or more template images comprises:
spatially aligning the one or more input images with one or more corresponding template images in accordance within a standard coordinate system such that the object represented in the one or more input images is aligned with a template object in the one or more template images;
spatially transforming the one or more input images to increase correspondence in shape of the object represented in the one or more input images with the template object in the one or more template images; and
spatially interpolating the one or more input images so as that the pixels in the spatially transformed one or more input images have the same size and spatially correspond to the pixels in the one or more template images in accordance with the standard coordinate system.

29. The method of claim 1, wherein the steps of spatially aligning, spatially transforming, and spatially interpolating are performed sequentially.

30. The method of claim 28, further comprising, before spatially aligning the one or more input images with the one or more template images, spatially aligning and/or spatially transforming the one or more input images so to align the object represented in the one or more input images with each another.

31. The method of claim 1, wherein the one or more input images are images generated by a magnetic resonance imaging procedure or medical imaging procedure.

32. The method of claim 1, wherein the one or more input images include at least one of: medical imaging images, magnetic resonance images, magnetic resonance T1-weighted images, magnetic resonance T2-weighted images, magnetic resonance spectroscopy images, and anatomic images.

33. The method of claim 1, wherein the object represented in the one or more input images is a visual representation of a brain, the classification model segmenting the visual representation of the brain into objects that include at least one of: tumors, edema, lesions, brain tumors, brain edema, brain lesions, multiple sclerosis lesions, areas of stroke, and areas of brain damage.

34. The method of claim 1, wherein the one or more input images comprises an image series of cross-sectional images taken in a common plane and offset with respect to one another so as to represent a volume, the one or more input images being arranged in the image series so as to spatially correspond to the respective cross-sections of the volume.

35. The method of claim 1, further comprising presenting a visual representation of the classification of each pixel or group of pixels on a display of the data processing system.

36. The method of claim 1, wherein the visual representation is provided by colour-coding each pixel or group of pixels in accordance with its respective classification.

37. The method of claim 1, wherein the visual representation is provided by delineating each pixel or group of pixels in accordance with its respective classification.

38. The method of claim 1, further comprising outputting or transmitting a computer data signal containing computer-execute code for presenting a visual representation of the classification of each pixel or group of pixels on a display device.

39. The method of claim 1, wherein each pixel is classified separately.

40. A data processing system for segmenting one or more input images into objects, each of the one or more input images each comprising a plurality of pixels, the data processing system comprising:
a display, one or more input devices, a memory, and a processor operatively connected to the display, input devices, and memory;
the memory having data and instructions stored thereon to configure the processor to:
align the one or more input images with one or more corresponding template images each comprising a plurality of pixels;
measure features of each of the one or more input images and one or more template images; and
classify each pixel, or a group of pixels, in the one or more input images based on the extracted features of the one or more input images and the one or more corresponding template images in accordance with a classification model mapping image properties or features to a respective class so as to segment the object represented in the one or more input images according to the classification of each pixel or group of pixels.

41. A data processing system for segmenting an object represented in one or more input images, each of the one or more input images each comprising a plurality of pixels, the data processing system comprising: a display, one or more input devices, a memory, and a processor operatively connected to the display, input devices, and memory; wherein the memory having data and instructions stored thereon to configure the processor to: perform the method of claim 1.

42. A computer-readable medium carrying data and instructions for programming a data processing system to perform the method of claim 1.

43. In a data processing system, a method for segmenting an object represented in one or more images, each of the one or more images comprising a plurality of pixels, the method comprising the steps of:
measuring image properties or extracting image features of the one or more images at a plurality of locations;
measuring image properties or extracting image features of one or more template images at a plurality of locations corresponding to the same locations in the one or more images, each of the template images comprising a plurality of pixels; and
classifying each pixel, or a group of pixels, in the one or more images based on the measured properties or extracted features of the one or more images and the one or more template images in accordance with a classification model mapping image properties or extracted features to respective classes so as to segment the object represented in the one or more images according to the classification of each pixel or group of pixels.
